(19) United States
(12) Patent Application Publication
(10) Pub. No.: US 2024/0388401 A1
(43) Pub. Date: Nov. 21, 2024

(54) REFERENCE RESOURCE CONFIGURATION FOR FULL-DUPLEX AND HALF-DUPLEX WIRELESS COMMUNICATIONS

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Ahmed Attia ABOTABL, San Diego, CA (US)

(21) Appl. No.: 18/622,341

(22) Filed: Mar. 29, 2024

Related U.S. Application Data
(60) Provisional application No. 63/501,224, filed on May 10, 2023.

(51) Int. Cl. H04L 5/00; H04B 7/06; H04L 5/14

(52) U.S. Cl. CPC H04L 5/0051; H04B 7/0626; H04L 5/14

(57) ABSTRACT

Methods, systems, and devices for wireless communication are described. Some wireless communications systems may support channel state information (CSI) reporting based on full-duplex reference signals, half-duplex reference signals, or both. A user equipment (UE) may receive, from a network entity, a CSI reporting configuration that includes one or more parameters for full-duplex CSI reporting, half-duplex CSI reporting, or both. The network entity may transmit a full-duplex reference signal, a half-duplex reference signal, or both to the UE based on the CSI reporting parameters. The UE may obtain measurements of the reference signals. The UE may transmit one or more CSI reports based on the measurements. The CSI reports may be transmitted at least a threshold time period after a corresponding reference resource. The threshold time period may be based on a duplexing mode associated with the CSI report.

### CROSS REFERENCE

The present Application for Patent claims the benefit of U.S. Provisional Patent Application No. 63/501,224 by IBRAHIM et al., entitled “REFERENCE RESOURCE CONFIGURATION FOR FULL-DUPLEX AND HALF-DUPLEX WIRELESS COMMUNICATIONS,” filed May 10, 2023, assigned to the assignee hereof, and expressly incorporated by reference herein.

### FIELD OF TECHNOLOGY

The following relates to wireless communication, including reference resource configuration for full-duplex and half-duplex wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, a network entity may communicate with a UE using full-duplex communications, half-duplex communications, or both. Full-duplex communications may be associated with uplink and downlink communications that occur at the same time or in at least partially overlapping time resources. Half-duplex communications may be associated with either uplink communications or downlink communications occurring at a given time.

### SUMMARY

The described techniques relate to improved methods, systems, devices, and apparatuses that support reference resource configuration for full-duplex and half-duplex wireless communications. For example, the described techniques enable a user equipment (UE) to perform channel state information (CSI) reporting based on full-duplex reference signals, half-duplex reference signals, or both. The UE may receive, from a network entity, a CSI reporting configuration that includes one or more parameters for full-duplex CSI reporting, half-duplex CSI reporting, or both. The one or more parameters may indicate reference resources for the CSI reporting. The reference resources may define a time resource as a timing reference for a measurement window, such as for determining the end of a measurement window for a CSI report. The reference resources may be full-duplex resources, half-duplex resources, or both. The network entity may transmit a full-duplex reference signal, a half-duplex reference signal, or both to the UE based on the CSI reporting parameters. The UE may obtain measurements of the reference signals and may determine (e.g., calculate or estimate) CSI parameters based on the measurements. The UE may transmit one or more CSI reports based on the measurements. The CSI reports may include the CSI parameters and may be transmitted at least a threshold time period after a corresponding reference resource, where the threshold time period may be based on a duplexing mode (e.g., half-duplex, full-duplex) associated with the CSI report.

A method for wireless communication at a UE is described. The method may include receiving one or more reference signals including one or more full-duplex reference signals, one or more half-duplex reference signals, or both, obtaining measurements of the one or more reference signals, the measurements associated with one or more reference resources that are associated with full-duplex communications, half-duplex communications, or both, and transmitting, at least a threshold time period after the one or more reference resources, one or more CSI reports based on the measurements of the one or more reference signals, where the threshold time period is based on a duplexing mode associated with the one or more CSI reports.

A UE for wireless communication is described. The UE may include one or more memories storing processor-executable code and one or more processors coupled with the one or more memories. The one or more processors may be individually or collectively operable to execute the code to cause the UE to receive one or more reference signals including one or more full-duplex reference signals, one or more half-duplex reference signals, or both, obtain measurements of the one or more reference signals, the measurements associated with one or more reference resources that are associated with full-duplex communications, half-duplex communications, or both, and transmit, at least a threshold time period after the one or more reference resources, one or more CSI reports based on the measurements of the one or more reference signals, where the threshold time period is based on a duplexing mode associated with the one or more CSI reports.

Another UE for wireless communication is described. The UE may include means for receiving one or more reference signals including one or more full-duplex reference signals, one or more half-duplex reference signals, or both, means for obtaining measurements of the one or more reference signals, the measurements associated with one or more reference resources that are associated with full-duplex communications, half-duplex communications, or both, and means for transmitting, at least a threshold time period after the one or more reference resources, one or more CSI reports based on the measurements of the one or more reference signals, where the threshold time period is based on a duplexing mode associated with the one or more CSI reports.

A non-transitory computer-readable medium storing code for wireless communication at a UE is described. The code may include instructions executable by a processor to receive one or more reference signals including one or more full-duplex reference signals, one or more half-duplex reference signals, or both, obtain measurements of the one or more reference signals, the measurements associated with one or more reference resources that are associated with full-duplex communications, half-duplex communications, or both, and transmit, at least a threshold time period after the one or more reference resources, one or more CSI reports based on the measurements of the one or more reference signals, where the threshold time period is based on a duplexing mode associated with the one or more CSI reports.

In some examples of the method, UEs, and non-transitory computer-readable medium described herein, the one or more reference signals include a full-duplex reference signal and a half-duplex reference signal, and obtaining the measurements of the one or more reference signals may include operations, features, means, or instructions for obtaining a first measurement of the full-duplex reference signal based on a first reference resource, where the first reference resource includes a resource that may be associated with a full-duplex CSI computation and that may be at least a first threshold time period before a first CSI reporting resource for transmission of a first CSI report of the one or more CSI reports, the first CSI report associated with a full-duplexing mode, or obtaining a second measurement of the half-duplex reference signal based on a second reference resource, where the second reference resource includes a resource that may be associated with half-duplex CSI computation and that may be at least a second threshold time period before a second CSI reporting resource for transmission of a second CSI report of the one or more CSI reports, the second CSI report associated with a half-duplexing mode, or both.

In some examples of the method, UEs, and non-transitory computer-readable medium described herein, transmitting the one or more CSI reports may include operations, features, means, or instructions for transmitting, via the first CSI reporting resource, the first CSI report including one or more full-duplex CSI parameters that may be based on the first measurement of the full-duplex reference signal and transmitting, via the second CSI reporting resource, the second CSI report including one or more half-duplex CSI parameters that may be based on the second measurement of the half-duplex reference signal.

In some examples of the method, UEs, and non-transitory computer-readable medium described herein, transmitting the one or more CSI reports may include operations, features, means, or instructions for transmitting, via one of the first CSI reporting resource or the second CSI reporting resource, a single CSI report including one or more CSI parameters that may be either based on the first measurement of the full-duplex reference signal or based on the second measurement of the half-duplex reference signal.

In some examples of the method, UEs, and non-transitory computer-readable medium described herein, the first threshold time period may be based on the first reference resource including the resource that may be associated with full-duplex CSI computation and on a quantity of reference signal resources for channel measurements by the UE and the second threshold time period may be based on the second reference resource including the resource that may be associated with half-duplex CSI computation and on the quantity of reference signal resources for the channel measurements by the UE.

In some examples of the method, UEs, and non-transitory computer-readable medium described herein, the one or more reference signals include a reference signal received via one or more full-duplex resources, via one or more half-duplex resources, or both, and obtaining the measurements of the reference signal may include operations, features, means, or instructions for obtaining a first measurement of the reference signal in the one or more full-duplex resources, where a first reference resource for the first measurement includes a resource that may be associated with full-duplex CSI computation and that may be at least a first threshold time period before a first CSI reporting resource for transmission of a first CSI report of the one or more CSI reports, the first CSI report associated with a full-duplexing mode, or obtaining a second measurement of the reference signal in the one or more half-duplex resources, where a second reference resource for the second measurement includes a resource that may be associated with half-duplex CSI computation and that may be at least a second threshold time period before a second CSI reporting resource for transmission of a second CSI report of the one or more CSI reports, the second CSI report associated with a half-duplexing mode, or both.

In some examples of the method, UEs, and non-transitory computer-readable medium described herein, a first duration of the first threshold time period may be based on the first reference resource being associated with the full-duplex CSI computation and on a quantity of reference signal resources for channel measurements by the UE, a second duration of the second threshold time period may be based on the second reference resource being associated with the half-duplex CSI computation and on the quantity of reference signal resources for channel measurements by the UE, and the second duration may be different than the first duration.

In some examples of the method, UEs, and non-transitory computer-readable medium described herein, the first reference resource may be associated with one or more CSI reference signals.

In some examples of the method, UEs, and non-transitory computer-readable medium described herein, the first reference resource may be associated with one or more CSI reference signals and one or more synchronization signal block (SSBs).

In some examples of the method, UEs, and non-transitory computer-readable medium described herein, transmitting the one or more CSI reports may include operations, features, means, or instructions for transmitting, via the first CSI reporting resource, the first CSI report including one or more full-duplex CSI parameters that may be based on the first measurement of the reference signal in the one or more full-duplex resources and transmitting, via the second CSI reporting resource, the second CSI report including one or more half-duplex CSI parameters that may be based on the second measurement of the reference signal in the one or more half-duplex resources.

In some examples of the method, UEs, and non-transitory computer-readable medium described herein, transmitting the one or more CSI reports may include operations, features, means, or instructions for transmitting, via one of the first CSI reporting resource or the second CSI reporting resource, a CSI report including either one or more full-duplex CSI parameters that may be based on the first measurement of the reference signal in the one or more full-duplex resources or one or more half-duplex CSI parameters that may be based on the second measurement of the reference signal in the one or more half-duplex resources.

A method for wireless communication at a network entity is described. The method may include transmitting one or more reference signals including one or more full-duplex reference signals, one or more half-duplex reference signals, or both and receiving, at least a threshold time period after one or more reference resources, one or more CSI reports based on measurements of the one or more reference signals, the measurements associated with the one or more reference resources that are associated with full-duplex communications, half-duplex communications, or both, where the threshold time period is based on a duplexing mode associated with the one or more CSI reports.

A network entity for wireless communication is described. The network entity may include one or more memories storing processor-executable code and one or more processors coupled with the one or more memories. The one or more processors may be individually or collectively operable to execute the code to cause the network entity to transmit one or more reference signals including one or more full-duplex reference signals, one or more half-duplex reference signals, or both and receive, at least a threshold time period after one or more reference resources, one or more CSI reports based on measurements of the one or more reference signals, the measurements associated with the one or more reference resources that are associated with full-duplex communications, half-duplex communications, or both, where the threshold time period is based on a duplexing mode associated with the one or more CSI reports.

Another network entity for wireless communication is described. The network entity may include means for transmitting one or more reference signals including one or more full-duplex reference signals, one or more half-duplex reference signals, or both and means for receiving, at least a threshold time period after one or more reference resources, one or more CSI reports based on measurements of the one or more reference signals, the measurements associated with the one or more reference resources that are associated with full-duplex communications, half-duplex communications, or both, where the threshold time period is based on a duplexing mode associated with the one or more CSI reports.

A non-transitory computer-readable medium storing code for wireless communication at a network entity is described. The code may include instructions executable by a processor to transmit one or more reference signals including one or more full-duplex reference signals, one or more half-duplex reference signals, or both and receive, at least a threshold time period after one or more reference resources, one or more CSI reports based on measurements of the one or more reference signals, the measurements associated with the one or more reference resources that are associated with full-duplex communications, half-duplex communications, or both, where the threshold time period is based on a duplexing mode associated with the one or more CSI reports.

In some examples of the method, network entities, and non-transitory computer-readable medium described herein, transmitting the one or more reference signals may include operations, features, means, or instructions for transmitting a full-duplex reference signal and transmitting a half-duplex reference signal.

In some examples of the method, network entities, and non-transitory computer-readable medium described herein, receiving the one or more CSI reports may include operations, features, means, or instructions for receiving, via a first CSI reporting resource, a first CSI report including one or more full-duplex CSI parameters that may be based on the full-duplex reference signal, where the first CSI reporting resource may be at least a first threshold time period after a first reference resource associated with the full-duplex reference signal and receiving, via a second CSI reporting resource, a second CSI report including one or more half-duplex CSI parameters that may be based on the half-duplex reference signal, where the second CSI reporting resource may be at least a second threshold time period after a second reference resource associated with the half-duplex reference signal.

In some examples of the method, network entities, and non-transitory computer-readable medium described herein, receiving the one or more CSI reports may include operations, features, means, or instructions for receiving a single CSI report including one or more CSI parameters that may be either based on the full-duplex reference signal or based on the half-duplex reference signal.

In some examples of the method, network entities, and non-transitory computer-readable medium described herein, transmitting the one or more reference signals may include operations, features, means, or instructions for transmitting a reference signal via one or more full-duplex resources, one or more half-duplex resources, or both.

In some examples of the method, network entities, and non-transitory computer-readable medium described herein, receiving the one or more CSI reports may include operations, features, means, or instructions for receiving, via a first CSI reporting resource, a first CSI report including one or more full-duplex CSI parameters that may be based on the reference signal transmitted via the one or more full-duplex resources, where the first CSI reporting resource may be at least a first threshold time period after a first reference resource associated with the one or more full-duplex resources and receiving, via a second CSI reporting resource, a second CSI report including one or more half-duplex CSI parameters that may be based on the reference signal transmitted via the one or more half-duplex resources, where the second CSI reporting resource may be at least a second threshold time period after a second reference resource associated with the one or more half-duplex resources.

In some examples of the method, network entities, and non-transitory computer-readable medium described herein, the first reference resource may be associated with one or more CSI reference signals.

In some examples of the method, network entities, and non-transitory computer-readable medium described herein, the first reference resource may be associated with one or more CSI reference signals and one or more SSBs.

In some examples of the method, network entities, and non-transitory computer-readable medium described herein, receiving the one or more CSI reports may include operations, features, means, or instructions for receiving, via a CSI reporting resource, a CSI report including either one or more full-duplex CSI parameters that may be based on the reference signal transmitted in the one or more full-duplex resources or one or more half-duplex CSI parameters that may be based on the reference signal transmitted in the one or more half-duplex resources.

A method for wireless communication at a UE is described. The method may include receiving an indication of one or more parameters for half-duplex CSI reporting, full-duplex CSI reporting, or both, the one or more parameters indicating one or more reference resources that include half-duplex reference resources, full-duplex reference resources, or both, receiving, via a transmission time interval (TTI), a reference signal, the TTI including one of the half-duplex reference resources or the full-duplex reference resources, and transmitting, in accordance with the one or more parameters, a CSI report according to a duplexing mode, where the duplexing mode includes one of a half-duplexing mode based on the TTI including the half-duplex reference resources or a full-duplexing mode based on the TTI including the full-duplex reference resources.

A UE for wireless communication is described. The UE may include one or more memories storing processor-executable code and one or more processors coupled with the one or more memories. The one or more processors may be individually or collectively operable to execute the code to cause the UE to receive an indication of one or more parameters for half-duplex CSI reporting, full-duplex CSI reporting, or both, the one or more parameters indicating one or more reference resources that include half-duplex reference resources, full-duplex reference resources, or both, receive, via a TTI, a reference signal, the TTI including one of the half-duplex reference resources or the full-duplex reference resources, and transmit, in accordance with the one or more parameters, a CSI report according to a duplexing mode, where the duplexing mode includes one of a half-duplexing mode based on the TTI including the half-duplex reference resources or a full-duplexing mode based on the TTI including the full-duplex reference resources.

Another UE for wireless communication is described. The UE may include means for receiving an indication of one or more parameters for half-duplex CSI reporting, full-duplex CSI reporting, or both, the one or more parameters indicating one or more reference resources that include half-duplex reference resources, full-duplex reference resources, or both, means for receiving, via a TTI, a reference signal, the TTI including one of the half-duplex reference resources or the full-duplex reference resources, and means for transmitting, in accordance with the one or more parameters, a CSI report according to a duplexing mode, where the duplexing mode includes one of a half-duplexing mode based on the TTI including the half-duplex reference resources or a full-duplexing mode based on the TTI including the full-duplex reference resources.

A non-transitory computer-readable medium storing code for wireless communication at a UE is described. The code may include instructions executable by a processor to receive an indication of one or more parameters for half-duplex CSI reporting, full-duplex CSI reporting, or both, the one or more parameters indicating one or more reference resources that include half-duplex reference resources, full-duplex reference resources, or both, receive, via a TTI, a reference signal, the TTI including one of the half-duplex reference resources or the full-duplex reference resources, and transmit, in accordance with the one or more parameters, a CSI report according to a duplexing mode, where the duplexing mode includes one of a half-duplexing mode based on the TTI including the half-duplex reference resources or a full-duplexing mode based on the TTI including the full-duplex reference resources.

Some examples of the method, UEs, and non-transitory computer-readable medium described herein may further include operations, features, means, or instructions for obtaining measurements of the reference signal, the measurements associated with a reference resource that may be associated with half-duplex CSI computation based on the TTI including the half-duplex reference resources, where the CSI report may be transmitted according to the half-duplexing mode.

Some examples of the method, UEs, and non-transitory computer-readable medium described herein may further include operations, features, means, or instructions for obtaining measurements of the reference signal, the measurements associated with a reference resource that may be associated with full-duplex CSI computation based on the TTI including the full-duplex reference resources, where the CSI report may be transmitted according to the full-duplexing mode.

In some examples of the method, UEs, and non-transitory computer-readable medium described herein, the reference resource includes one or more downlink resources and may be exclusive of uplink resources based on the reference resource being associated with the full-duplex CSI computation.

A method for wireless communication at a network entity is described. The method may include transmitting an indication of one or more parameters for half-duplex CSI reporting, full-duplex CSI reporting, or both, the one or more parameters indicating one or more reference resources that include half-duplex reference resources, full-duplex reference resources, or both, transmitting, via a TTI, a reference signal, the TTI including one of the half-duplex reference resources or the full-duplex reference resources, and receiving a CSI report associated with a duplexing mode, where the duplexing mode includes one of a half-duplexing mode based on the TTI including the half-duplex reference resources or a full-duplexing mode based on the TTI including the full-duplex reference resources.

A network entity for wireless communication is described. The network entity may include one or more memories storing processor-executable code and one or more processors coupled with the one or more memories. The one or more processors may be individually or collectively operable to execute the code to cause the network entity to transmit an indication of one or more parameters for half-duplex CSI reporting, full-duplex CSI reporting, or both, the one or more parameters indicating one or more reference resources that include half-duplex reference resources, full-duplex reference resources, or both, transmit, via a TTI, a reference signal, the TTI including one of the half-duplex reference resources or the full-duplex reference resources, and receive a CSI report associated with a duplexing mode, where the duplexing mode includes one of a half-duplexing mode based on the TTI including the half-duplex reference resources or a full-duplexing mode based on the TTI including the full-duplex reference resources.

Another network entity for wireless communication is described. The apparatus may include means for transmitting an indication of one or more parameters for half-duplex CSI reporting, full-duplex CSI reporting, or both, the one or more parameters indicating one or more reference resources that include half-duplex reference resources, full-duplex reference resources, or both, means for transmitting, via a TTI, a reference signal, the TTI including one of the half-duplex reference resources or the full-duplex reference resources, and means for receiving a CSI report associated with a duplexing mode, where the duplexing mode includes one of a half-duplexing mode based on the TTI including the half-duplex reference resources or a full-duplexing mode based on the TTI including the full-duplex reference resources.

A non-transitory computer-readable medium storing code for wireless communication at a network entity is described. The code may include instructions executable by a processor to transmit an indication of one or more parameters for half-duplex CSI reporting, full-duplex CSI reporting, or both, the one or more parameters indicating one or more reference resources that include half-duplex reference resources, full-duplex reference resources, or both, transmit, via a TTI, a reference signal, the TTI including one of the half-duplex reference resources or the full-duplex reference resources, and receive a CSI report associated with a duplexing mode, where the duplexing mode includes one of a half-duplexing mode based on the TTI including the half-duplex reference resources or a full-duplexing mode based on the TTI including the full-duplex reference resources.

In some examples of the method, network entities, and non-transitory computer-readable medium described herein, receiving the CSI report may include operations, features, means, or instructions for receiving the CSI report according to the half-duplexing mode based on the TTI including the half-duplex reference resources, where a reference resource associated with the CSI report includes a half-duplex reference resource.

In some examples of the method, network entities, and non-transitory computer-readable medium described herein, receiving the CSI report may include operations, features, means, or instructions for receiving the CSI report according to the full-duplexing mode based on the TTI including the full-duplex reference resources, where a reference resource associated with the CSI report includes a full-duplex reference resource.

In some examples of the method, network entities, and non-transitory computer-readable medium described herein, the reference resource includes one or more downlink resources and may be exclusive of uplink resources based on the reference resource being the full-duplex reference resource.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports reference resource configuration for full-duplex and half-duplex wireless communications in accordance with one or more aspects of the present disclosure.

FIG. 3 shows an example of a network architecture that supports reference resource configuration for full-duplex and half-duplex wireless communications in accordance with one or more aspects of the present disclosure.

FIG. 4 shows examples of full-duplex schemes that support reference resource configuration for full-duplex and half-duplex wireless communications in accordance with one or more aspects of the present disclosure.

FIG. 5 shows examples of channel state information (CSI) reporting schemes that support reference resource configuration for full-duplex and half-duplex wireless communications in accordance with one or more aspects of the present disclosure.

FIG. 6 shows an example of a timing diagram that supports reference resource configuration for full-duplex and half-duplex wireless communications in accordance with one or more aspects of the present disclosure.

FIG. 7 shows an example of a wireless communications system that supports reference resource configuration for full-duplex and half-duplex wireless communications in accordance with one or more aspects of the present disclosure.

FIG. 8 shows an example of a process flow that supports reference resource configuration for full-duplex and half-duplex wireless communications in accordance with one or more aspects of the present disclosure.

FIG. 9 shows an example of a process flow that supports reference resource configuration for full-duplex and half-duplex wireless communications in accordance with one or more aspects of the present disclosure.

FIGS. 10 and 11 show block diagrams of devices that support reference resource configuration for full-duplex and half-duplex wireless communications in accordance with one or more aspects of the present disclosure.

FIG. 12 shows a block diagram of a communications manager that supports reference resource configuration for full-duplex and half-duplex wireless communications in accordance with one or more aspects of the present disclosure.

FIG. 13 shows a diagram of a system including a device that supports reference resource configuration for full-duplex and half-duplex wireless communications in accordance with one or more aspects of the present disclosure.

FIGS. 14 and 15 show block diagrams of devices that support reference resource configuration for full-duplex and half-duplex wireless communications in accordance with one or more aspects of the present disclosure.

FIG. 16 shows a block diagram of a communications manager that supports reference resource configuration for full-duplex and half-duplex wireless communications in accordance with one or more aspects of the present disclosure.

FIG. 17 shows a diagram of a system including a device that supports reference resource configuration for full-duplex and half-duplex wireless communications in accordance with one or more aspects of the present disclosure.

FIGS. 18 through 22 show flowcharts illustrating methods that support reference resource configuration for full-duplex and half-duplex wireless communications in accordance with one or more aspects of the present disclosure.

### DETAILED DESCRIPTION

In some wireless communication systems, a user equipment (UE) may communicate with a network entity via transmission time intervals (TTIs) that support either full-duplex communications (e.g., uplink and downlink at the same time) or half-duplex communications (e.g., either uplink or downlink at a given time). The UE may measure one or more reference signals (e.g., channel state information (CSI) reference signals (CSI-RSs), or some other type of reference signal) and may transmit a CSI report that indicates parameters associated with the measurements. The UE may transmit two separate CSI reports that are associated with full-duplex communications and half-duplex communications, respectively, or the UE may transmit a single CSI report that is associated with one of the full-duplex or the half-duplex communications. The UE may measure either one or two reference signals to obtain the CSI measurements, where the reference signals may be received via full-duplex resources, half-duplex resources, or both. In some cases, the UE may determine a duplexing mode (e.g., half-duplex, full-duplex) associated with the CSI report based on either the CSI report configuration or the reference signal resources.

Techniques, systems, and devices described herein support protocols for CSI report timing for a UE that utilizes full-duplex and half-duplex communications. The CSI report timing may correspond to selection of a reference resource for CSI measurements. The UE may utilize the reference resource to obtain CSI measurements. For example, in a time domain, the reference resource may define a time resource as a timing reference for determining the end of a measurement window for a CSI report (e.g., a CSI report may not include any channel and/or interference measurements obtained after the timing reference). As described herein, the reference resource may be defined as either a half-duplex (e.g., downlink) resource or a full-duplex resource. A half-duplex resource and a full-duplex resource may represent resources that are used for half-duplex or full-duplex communications and CSI computation, respectively. The reference resource may occur, by definition, at least a threshold time period before a CSI reporting resource in which the CSI report is scheduled for transmission. The threshold time period may be based on a quantity of resources allocated for channel measurement, a subcarrier spacing (SCS) for communications, and one or more constant values. The threshold time period may be different for half-duplex reference resources than full-duplex reference resources, in some examples. The described techniques may thereby provide for a CSI report timing to be based on whether the CSI report is a full-duplex or half-duplex CSI report, which may improve communication reliability.

The techniques described herein may further provide one or more protocols or techniques for a UE to determine a duplexing type for CSI reporting in scenarios in which the CSI report configuration supports either full-duplex or half-duplex CSI reporting and the reference signal resources can be either full-duplex or half-duplex. In such scenarios, the UE may determine a duplexing mode to use based on a type of TTI via which a reference signal is received. For example, if the reference signal is received via a full-duplex slot, the UE may use full-duplex CSI reporting, and if the reference signal is received via a half-duplex slot, the UE may use half-duplex CSI reporting. The UE may utilize full-duplex or half-duplex reference resources for full-duplex and half-duplex CSI reporting, respectively. If the reference resource is full-duplex (e.g., sub-band full-duplex (SBFD)), the UE may assume, when measuring CSI for the reference resource, that the reference resource includes downlink resources and excludes uplink resources. The UE may thereby support reliable and accurate CSI estimation and reporting using any combination of full-duplex resources and half-duplex resources.

Aspects of the disclosure are initially described in the context of wireless communications systems. Additional aspects of the disclosure are described with reference to example full-duplex schemes, example CSI reporting schemes, timing diagrams, and process flows. Aspects of the disclosure are further illustrated by and described with reference to apparatus diagrams, system diagrams, and flowcharts that relate to reference resource configuration for full-duplex and half-duplex wireless communications.

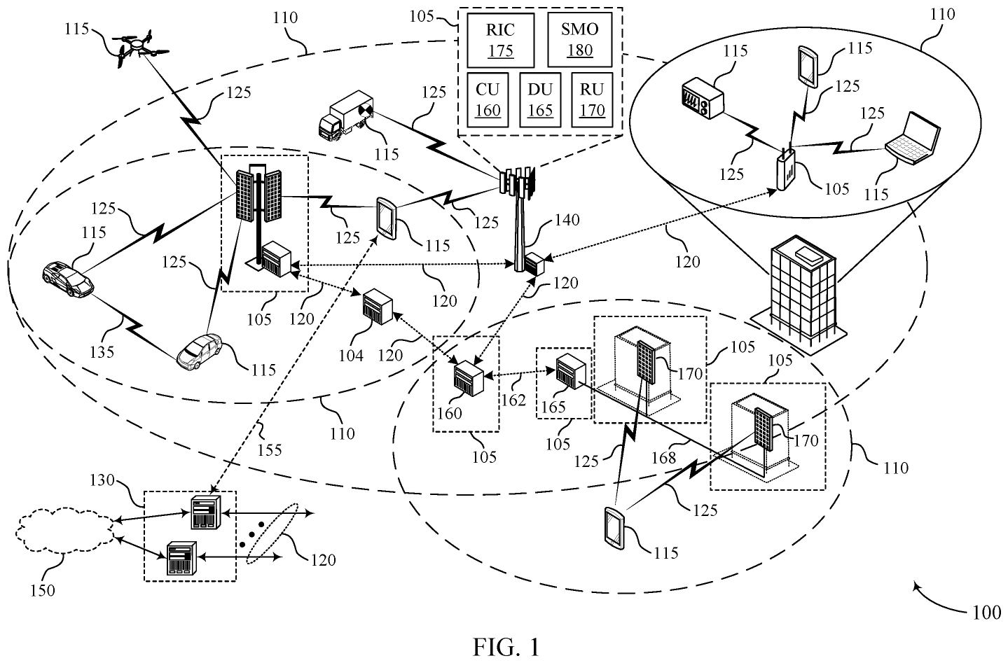

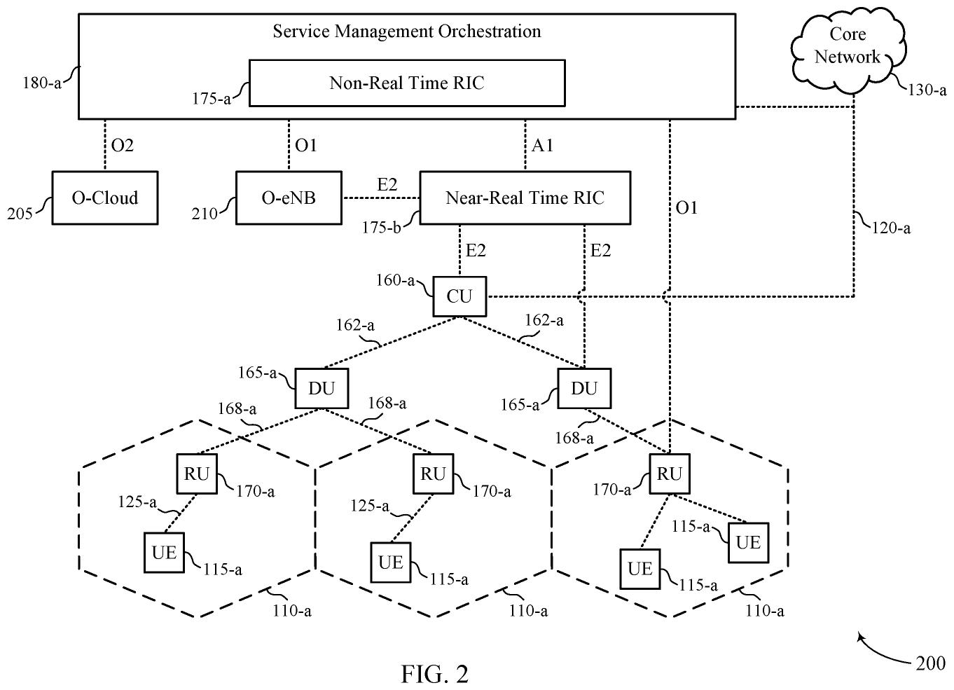

FIG. 1 shows an example of a wireless communications system 100 that supports reference resource configuration for full-duplex and half-duplex wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support reference resource configuration for full-duplex and half-duplex wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and SCS may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported SCS, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a TTI. In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, a UE 115 in the wireless communications system 100 may perform CSI reporting based on full-duplex reference signals, half-duplex reference signals, or both. The UE 115 may receive, from a network entity 105, a CSI reporting configuration that includes one or more parameters for full-duplex CSI reporting, half-duplex CSI reporting, or both. The one or more parameters may indicate reference resources for the CSI reporting. The reference resources may define a time resource as a timing reference for determining the end of a measurement window for a CSI report. The reference resources may be full-duplex resources, half-duplex resources, or both. The network entity 105 may transmit a full-duplex reference signal, a half-duplex reference signal, or both to the UE 115 based on the CSI reporting parameters. The UE 115 may obtain measurements of the reference signals and may determine (e.g., calculate or estimate) CSI parameters based on the measurements. The UE 115 may transmit one or more CSI reports based on the measurements. The CSI reports may include the CSI parameters and may be transmitted at least a threshold time period after a corresponding reference resource, where the threshold time period may be based on a duplexing mode associated with the CSI report.

FIG. 2 shows an example of a network architecture 200 (e.g., a disaggregated base station architecture, a disaggregated RAN architecture) that supports reference resource configuration for full-duplex and half-duplex wireless communications in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

As described herein, a UE 115-a may perform CSI reporting based on full-duplex reference signals, half-duplex reference signals, or both. The UE 115-a may receive, from a network entity 105 (e.g., from the network 130-a via an RU 170-a, DU 165-a CU 160-a, or any combination thereof), a CSI reporting configuration that includes one or more parameters for full-duplex CSI reporting, half-duplex CSI reporting, or both. The one or more parameters may indicate reference resources for the CSI reporting. The reference resources may define a time resource as a timing reference for determining the end of a measurement window for a CSI report. The reference resources may be full-duplex resources, half-duplex resources, or both. The UE 115-a may receive a full-duplex reference signal, a half-duplex reference signal, or both from the RU 170-a based on the CSI reporting parameters. The UE 115-a may obtain measurements of the reference signals and may determine (e.g., calculate or estimate) CSI parameters based on the measurements. The UE 115-a may transmit one or more CSI reports based on the measurements. The CSI reports may include the CSI parameters and may be transmitted at least a threshold time period after a corresponding reference resource, where the threshold time period may be based on a duplexing mode associated with the CSI report.

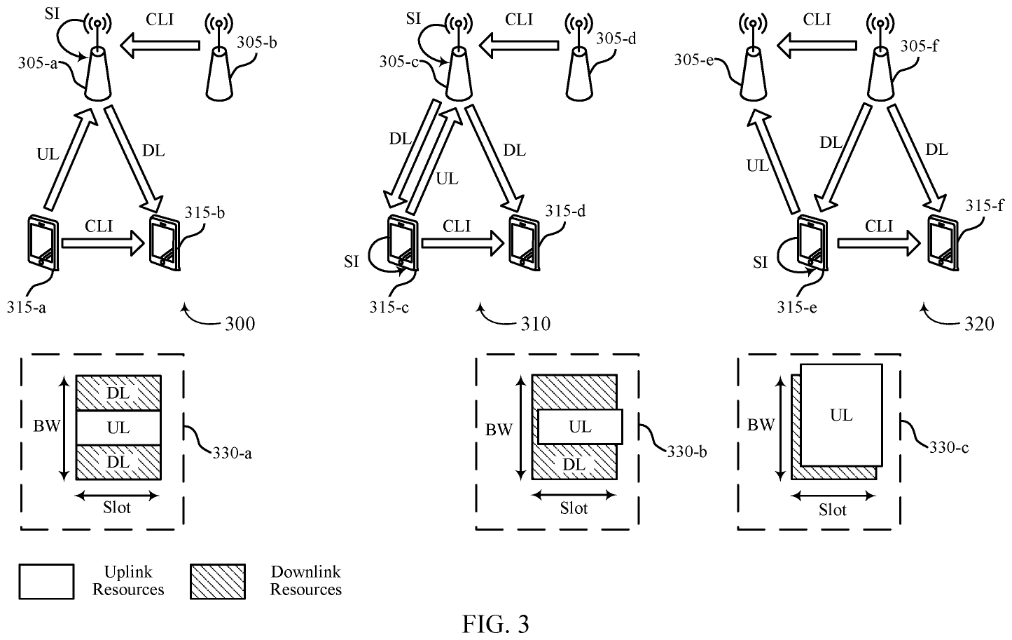

FIG. 3 shows example full-duplex schemes that support reference resource configuration for full-duplex and half-duplex wireless communications in accordance with one or more aspects of the present disclosure. The full-duplex schemes may implement or be implemented by aspects of the wireless communications system 100. For example, as shown in FIG. 3, examples 300, 310, and 320 include one or more UEs 315 in communication with one or more network entities 305 in a wireless network that supports full-duplex communication. The UEs 315 and the network entities 305 may represent examples of a UE 115 and a network entity 105 as described herein. In general, as described herein, utilizing a full-duplexing communication mode may provide reduced latency by permitting a downlink transmission to occur in an uplink-only slot and/or by allowing an uplink transmission to occur in a downlink-only slot. In addition, full-duplex communication may enhance spectral efficiency or throughput per cell or per UE 315 and/or enable more efficient resource utilization by simultaneously utilizing time and frequency resources for downlink and uplink communication.

Example 300 includes a UE 315-a and a UE 315-b in communication with a network entity 305-a operating in a full-duplexing mode. In this example, the UE 315-a and the UE 315-b may operate in a half-duplexing mode. For example, as shown in FIG. 3, the UE 315-a may transmit one or more uplink transmissions to the network entity 305-a, and the UE 315-b may concurrently receive one or more downlink transmissions from the network entity 305-a. Accordingly, in the example 300, the network entity 305-a is operating in a full-duplexing mode, and the UEs 315-a and 315-b are each operating in a half-duplexing mode.

As shown by example 300, there may be various forms of interference that may degrade downlink reception performance at the one or more UEs 315 and/or uplink reception performance at the network entity 305 operating in the full-duplexing mode. For example, as shown, the network entity 305-a may experience cross-link interference (CLI) caused by downlink transmissions from a network entity 305-b that may be located in an adjacent or nearby cell. Further, as shown, the uplink transmission from the UE 315-a to the network entity 305-a may cause CLI at the UE 315-b (e.g., CLI that interferes with downlink reception at the UE 315-b). Further, as shown, the network entity 305-a may experience self-interference, where the downlink transmission to the UE 315-b interferes with reception of the uplink transmission from the UE 315-a. For example, as described herein, self-interference may generally occur when a transmitted signal leaks into a receive port and/or when an object in a surrounding environment reflects a transmitted signal back to a receive port (e.g., causing a clutter echo effect), thus interfering with reception of a desired signal at the receive port.

In general, the full-duplexing mode used by the network entity 305-a in example 300 may be illustrated by the frequency resource allocation 330-a within an example slot. Such a full-duplexing mode may be referred to as a SBFD mode, in some examples, which may also be referred to as “sub-band frequency division duplex (SBFDD),” “flexible duplex,” or “FDD in unpaired spectrum.” In SBFD, a UE 315 may transmit an uplink communication to a network entity 305 and receive a downlink communication from the network node at the same time, but on different frequency resources. For example, the different frequency resources may be sub-bands of a frequency band, such as a TDD band. In this case, the frequency resources used for downlink communication may be separated from the frequency resources used for uplink communication, in the frequency domain, by a guard band (not illustrated in FIG. 3). As illustrated by the frequency resource allocation 330-a, in this example, a component carrier bandwidth is divided into non-overlapping uplink and downlink sub-bands, where an uplink sub-band includes uplink time and frequency resources and a downlink sub-band includes downlink time and frequency resources.

As further shown in FIG. 3, in example 310, a UE 315-c may communicate with a network entity 305-c in a full-duplexing mode. For example, in example 310, the UE 315-c may receive one or more downlink transmissions from the network entity 305-c, and the UE 315-c may concurrently transmit one or more uplink transmissions to the network entity 305-c. Accordingly, in example 310, the network entity 305-c and the UE 315-c are both operating in a full-duplexing mode. Further, as shown, the network entity 305-c may be communicating with a UE 315-d operating in a half-duplex mode.

As shown in FIG. 3, the UE 315-c may experience self-interference, where the uplink transmission to the network entity 305-c interferes with reception of the downlink transmission from the network entity 305-c. Additionally, or alternatively, the UE 315-c may cause cross-link interference at the UE 315-d, where the uplink transmission to the network entity 305-c interferes with downlink reception at the UE 315-d. Additionally, in example 310, the network entity 305-c may experience CLI caused by one or more downlink transmissions from a different network entity 305-d interfering with reception of the uplink transmission from the UE 315-c. The network entity 305-c may additionally, or alternatively, experience self-interference, where downlink transmission(s) to the UE 315-c and/or the UE 315-d interferes with reception of the uplink transmission from the UE 315-c.

In example 310, the full-duplexing mode used by the network entity 305-c and the UEs 315-c and 315-d may be illustrated by any of the frequency resource allocations 330-a, 330-b, or 330-c shown within example slots. For example, the full-duplex communication may be performed in an SBFD mode, where a component carrier bandwidth is divided into non-overlapping uplink and downlink sub-bands, as shown in frequency resource allocation 330-a. Additionally, or alternatively, the full-duplex communication may be performed in an in-band full-duplex (IBFD) mode, where uplink and downlink resources partially overlap, as shown in frequency resource allocation 330-b, or where the uplink and downlink resources fully overlap, as shown in frequency resource allocation 330-c. In IBFD, a UE 315 may transmit an uplink communication to a network entity 305 and receive a downlink communication from the network entity 305 on the same time and frequency resources. As shown in the frequency resource allocation 330-b, in a first example of IBFD, the time and frequency resources for uplink communication may partially overlap with the time and frequency resources for downlink communication (e.g., some time and frequency resources are reserved for uplink communication only). As shown in the frequency resource allocation 330-c, in a second example of IBFD, the time and frequency resources for uplink communication may fully overlap with the time and frequency resources for downlink communication (e.g., all time and frequency resources allocated to uplink communication are also available for downlink communication).

As further shown in FIG. 3, in example 320, a UE 315-e may communicate with a network entity 305-e and a network entity 305-f in a full-duplexing mode (e.g., a multi-TRP mode). For example, in example 320, the UE 315-c may transmit one or more uplink transmissions to the network entity 305-e, and the UE 315-e may concurrently receive one or more downlink transmissions from the network entity 305-f. Accordingly, in example 320, the UE may be operating in a full-duplexing mode, and the network entities 305-e and 305-b may both be operating in a half-duplexing mode.

As shown in FIG. 3, the UE 315-e may experience self-interference, where the uplink transmission to the network entity 305-e interferes with reception of the downlink transmission from the network entity 305-f. Further, the uplink transmission by the UE 315-e may cause CLI at a different UE 315-f that is receiving a downlink transmission from the network entity 305-f. Further, as shown, the downlink transmission by the network entity 305-f may cause CLI interfering with reception of the uplink transmission from the UE 315-e at the network entity 305-e.

In the example 320, the full-duplexing mode used by the network entity 305-e, the network entity 305-f, and the UEs 315-e and 315-f may be illustrated by any of the frequency resource allocations 330-a, 330-b, or 330-c shown within example slots. For example, the full-duplex communication may be performed in an SBFD mode, where a component carrier bandwidth is divided into non-overlapping uplink and downlink sub-bands, as shown in frequency resource allocation 330-a. Additionally, or alternatively, the full-duplex communication may be performed in an IBFD mode, where uplink and downlink resources partially overlap, as shown in frequency resource allocation 330-b, or where the uplink and downlink resources fully overlap, as shown in frequency resource allocation 330-c.

In some examples, slots for wireless communications may be allocated for downlink communication only (e.g., “D” slots), for uplink communication only (e.g., “U” slots), or for both uplink and downlink communications (e.g., “D+U” slots). In some examples, an uplink and downlink slot may be referred to as a full-duplex slot or an SBFD slot, and slot that is allocated for only one of uplink or downlink communications be referred to as a half-duplex slot or a non-SBFD slot. A “D+U” slot may be a slot in which a frequency bandwidth is used for both uplink and downlink transmissions. The downlink and uplink transmissions may occur in overlapping bands (e.g., IBFD) or adjacent bands (e.g., SBFD). In a given symbol of a “D+U” slot, a UE 315 that supports half-duplex communications, such as the UEs 315-a and 315-b illustrated in the example 300, may either transmit in the uplink band(s) or receive in the downlink band(s). In a given symbol of a “D+U” slot, a UE 315 that supports full-duplex communications, such as the UEs 315-c through 315-f illustrated in the examples 310 and 320, may transmit in the uplink band(s) and/or receive in the downlink band(s) in the same slot. In some examples, a “D+U” slot may contain downlink-only symbols, uplink-only symbols, or full-duplex symbols (e.g., allocated for but uplink and downlink).

As indicated above, FIG. 3 is provided as an example. Other examples of full-duplexing schemes may differ from what is described with regard to FIG. 3.

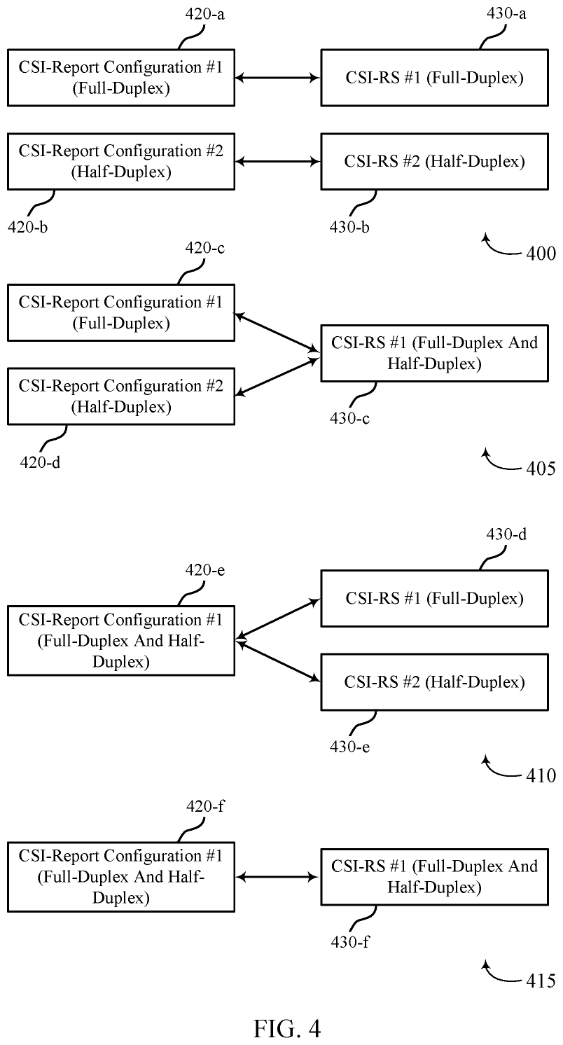

FIG. 4 shows example CSI reporting schemes for full-duplex communications that support reference resource configuration for full-duplex and half-duplex wireless communications in accordance with one or more aspects of the present disclosure. The example CSI reporting schemes may implement or be implemented by aspects of the wireless communications system 100 or the example full-duplexing deployments, as described with reference to FIGS. 1-3. For example, the examples 400, 405, 410, and 415 of CSI reporting schemes illustrate example configurations for a UE to report CSI associated with measurements of periodic or semi-persistent reference signals, such as CSI-RSs. The UE may transmit the CSI report to a network entity, which may represent examples of corresponding devices as described herein. In this example, the UE may support full-duplex communications (e.g., an SBFD-aware UE).

In a wireless network, CSI may generally include various parameters that relate to properties associated with a wireless channel and/or represent how a signal propagates from a transmitter to a receiver based on the combined effect of scattering, fading, and/or power decay with distance. Accordingly, a network entity may use CSI obtained by a UE to adapt transmissions to current channel conditions, which may increase reliability and/or throughput in the wireless network.

CSI may be obtained based on one or more reference signal transmissions (e.g., CSI-RSs or SSBs) that may be used for downlink and/or uplink channel estimation. For example, in some aspects, a CSI-RS may carry information used for downlink channel estimation (e.g., downlink CSI acquisition), which a network entity may use for scheduling, link adaptation, or beam management, among other examples. The network entity may configure a CSI-RS for a UE, and the UE may measure the configured CSI-RS. Based on the measurements, the UE may perform channel estimation and may report channel estimation parameters to the network entity (e.g., in a CSI report), such as a channel quality indicator (CQI), a precoding matrix indicator (PMI), a CSI-RS resource indicator (CRI), a layer indicator (LI), a rank indicator (RI), or an RSRP, among other examples. The network entity may use the CSI report to select transmission parameters for downlink communications to the UE, such as a quantity of transmission layers (e.g., a rank), a precoding matrix (e.g., a precoder), an MCS, or a refined downlink beam (e.g., using a beam refinement procedure or a beam management procedure), among other examples.

As described with reference to FIG. 3, the UE may communicate via one or more types of resources, including full-duplex resources and half-duplex resources (e.g., full-duplex and half-duplex slots or symbols or other types of resources). Full-duplex resources may be resources in which full-duplex communications or exchanged, such as a slot or symbol that is used to convey both uplink and downlink data. Half-duplex resources may be resources in which half-duplex communications are exchanged, such as a slot or a symbol that is used to convey only uplink communications or only downlink communications. CSI computation by the UE may be different in different resource types. As such, methods for CSI computation in half-duplex resources, full-duplex resources, or both is described herein. The example CSI reporting schemes illustrate different example techniques for configuring CSI reporting and reference signal resources to support half-duplex and/or full-duplex CSI computation.

The UE may receive, from a network entity, a CSI report configuration that indicates one or more parameters that configure the UE to report one or more CSI reports. The CSI report configuration may indicate parameters for full-duplex CSI reporting, half-duplex CSI reporting, or both. In some examples, as illustrated in the examples 300 and 405, the UE may be configured with separate CSI reporting for full-duplex symbols and half-duplex symbols (e.g., SBFD and non-SBFD symbols). That is, the UE may be configured to transmit two CSI reports, where a first CSI report includes CSI information calculated based on measurements of full-duplex resources, and a second CSI report includes CSI information calculated based on measurements of half-duplex resources. Additionally, or alternatively, as illustrated in examples 410 and 415, the UE may be configured with a same CSI reporting for full-duplex and half-duplex resources (e.g., SBFD and non-SBFD symbols). That is, the UE may be configured to transmit a single CSI report that includes CSI information based on measurements of half-duplex resources, measurements of full-duplex resources, or both.

In some examples, as illustrated in the examples 300 and 410, one or more reference signals may be received via two reference signal resources (referred to as CSI-RS resources in some examples). For example, a first CSI-RS 430-a or 430-d (e.g., CSI-RS #1) may be transmitted, by a network entity, via full-duplex resources. That is, the CSI-RSs 430-a and 430-d may be transmitted via transmission occasions in full-duplex symbols only. A second CSI-RS 430-b or 430-c (e.g., CSI-RS #2) may be transmitted, by the network entity, via half-duplex resources. That is, the CSI-RSs 430-b and 430-c may be transmitted via transmission occasions in half-duplex (non-SBFD) symbols only.

In some other examples, as illustrated in the examples 405 and 415, one or more reference signals may be received via a single reference signal resource. A single CSI-RS 430-c or 430-f (e.g., CSI-RS #1 for full-duplex and half-duplex) may be transmitted, by a network entity, via one or more full-duplex resources, half-duplex resources, or both. For example, the CSI-RSs 430-c and 430-f may be transmitted via transmission occasions in both full-duplex (e.g., SBFD) and half-duplex (e.g., non-SBFD) symbols. Although the reference signals are illustrated as CSI-RSs 430 in FIG. 4, it is to be understood that the network entity may transmit one or more other types of reference signals to the UE for channel measurement, including synchronization signal blocks (SSBs), or other types of reference signals.

In the example 300, the UE may be configured to transmit two CSI reports responsive to measurements of two CSI-RSs 430-a and 430-b. The UE may measure the CSI-RS 430-a received via full-duplex resources and calculate one or more CSI parameters for full-duplex communications based on the measurements. The UE may transmit a first CSI report according to the CSI report configuration 420-a that indicates the CSI parameters for full-duplex communications. That is, the first CSI report may be associated with the full-duplex CSI-RS 430-a. The UE may similarly measure the CSI-RS 430-b received via half-duplex resources and may calculate one or more CSI parameters for half-duplex communications based on the measurements. The UE may transmit a second CSI report according to the CSI report configuration 420-b that indicates the CSI parameters for half-duplex communications. The second CSI report may be associated with the half-duplex CSI-RS 430-b. The duplexing type (e.g., full-duplex or half-duplex) of each of the CSI reports in this example may be based on or indicated via the CSI report configurations 420-a and 420-b. In this example, there may be one CSI reporting for each of full-duplex and half-duplex symbols associated with a CSI-RS 430 restricted to the full-duplex or half-duplex symbols, respectively.

In the example 405, the UE may be configured to transmit two CSI reports responsive to measurements of a single CSI-RS 430-c. The UE may measure the CSI-RS 430-c received via full-duplex and half-duplex resources. In some examples, the UE may obtain first measurements of the CSI-RS 430-c in the full-duplex resources and second measurements of the CSI-RS 430-c in half-duplex resources. The UE may calculate or estimate one or more CSI parameters for full-duplex communications based on the first measurements and one or more CSI parameters for half-duplex communications based on the second measurements. The UE may transmit a first CSI report according to the CSI report configuration 420-c. The first CSI report may indicate the CSI parameters for full-duplex communications based on the first measurements of the CSI-RS 430-c in the full-duplex resources. The UE may transmit a second CSI report according to the CSI report configuration 420-d. The second CSI report may indicate the CSI parameters for half-duplex communications based on the second measurements of the CSI-RS 430-c in the half-duplex resources. The duplexing type (e.g., full-duplex or half-duplex) of each of the CSI reports in this example may be based on or indicated via the CSI report configurations 420-c and 420-d.

Both of the first and second CSI reports may thereby be associated with the same CSI-RS 430-c. In this example, there may be one CSI reporting for each of full-duplex and half-duplex symbols, where each CSI report is derived based on a same CSI-RS 430 that can be in full-duplex and half-duplex symbols. A CSI report for full-duplex or half-duplex may be derived based on measurements of the CSI-RS 430 in full-duplex or half-duplex symbols only, respectively. That is, the UE may only consider CSI-RS resources in resources having a same duplexing type as the corresponding CSI report configuration 420.

In the example 410, the UE may be configured to transmit a single CSI report responsive to measurements of two CSI-RSs 430-d and 430-c, which may be received via (e.g., restricted to) full-duplex symbols and half-duplex symbols, respectively. The UE may measure the CSI-RS 430-d received via full-duplex resources. Additionally, or alternatively, the UE may measure the CSI-RS 430-c received via half-duplex resources. The UE may thereby obtain first measurements associated with full-duplex communications, second measurements associated with half-duplex communications, or both. The UE may determine one or more CSI parameters for full-duplex communications based on the first measurements and one or more CSI parameters for half-duplex communications based on the second measurements. The UE may transmit, to a network entity, a single CSI report for full-duplex and half-duplex communications according to the CSI report configuration 420-c. The CSI report may include the one or more CSI parameters for full-duplex communications, the one or more CSI parameters for half-duplex communications, or both. A duplexing type for the CSI reporting may be inherited from the CSI-RS resource (e.g., the resource may be restricted to either full-duplex or half-duplex slots). In this example, the same CSI report may be associated with two CSI-RS resources.

In the example 415, the UE may be configured to transmit a single CSI report responsive to measurements of a single CSI-RS 430-f, which may be received via full-duplex symbols, half-duplex symbols, or both. The UE may measure the CSI-RS 430-f received via full-duplex and half-duplex resources. In some examples, the UE may obtain first measurements of the CSI-RS 430-f in the full-duplex resources, or second measurements of the CSI-RS 430-f in half-duplex resources, or both. The UE may calculate or estimate one or more CSI parameters for full-duplex communications based on the first measurements and one or more CSI parameters for half-duplex communications based on the second measurements. The UE may transmit a CSI report according to the CSI report configuration 420-f. The first CSI report may indicate the CSI parameters for full-duplex communications based on the first measurements of the CSI-RS 430-f in the full-duplex resources, the CSI parameters for half-duplex communications based on the second measurements of the CSI-RS 430-f in the half-duplex resources, or both.

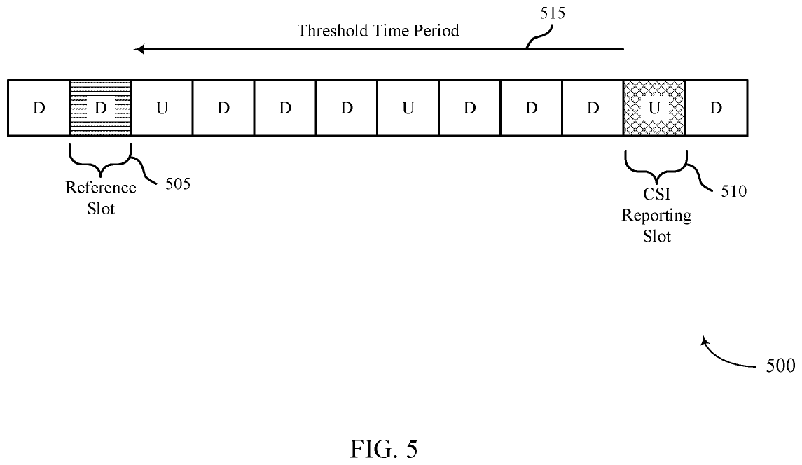

As described herein, in the example 415, the UE may determine a duplexing type for the CSI reporting based on one or more CSI-RS measurement occasions. For example, the duplexing mode of the CSI report may not be defined in the CSI report configuration 420-f or tied to a CSI resource, so the UE may determine whether an occasion of the CSI report is for full-duplex or half-duplex CSI based on a type of slot associated with a corresponding instance of the CSI-RS 430-f. For example, if the CSI-RS 430-f is received via a slot allocated for full-duplex communications, the CSI report may be a full-duplex CSI report. If the CSI-RS 430-f is received via a slot allocated for half-duplex communications, the CSI report may be a half-duplex CSI report. In some examples, the UE may transmit multiple instances of the CSI report each associated with a different duplexing type. For example, the CSI report configuration 420-f may indicate that both full-duplex and non-duplex CSI is to be generated and sent in different instances of the CSI report. Such duplexing mode determination may be based on a type of reference resources, which may be described in further detail elsewhere herein, including with reference to FIG. 5. As described in further detail with reference to FIG. 5, the UE may utilize one or more reference resources to determine a timing for transmission of the CSI report.

As indicated above, FIG. 4 is provided as an example. Other examples of CSI reporting schemes may differ from what is described with regard to FIG. 4.

FIG. 5 shows an example of a timing diagram 500 for CSI reporting that supports reference resource configuration for full-duplex and half-duplex wireless communications in accordance with one or more aspects of the present disclosure. The timing diagram 500 may implement or be implemented by aspects of the wireless communications system 100, the example full-duplexing deployments, and the example CSI reporting schemes, as described with reference to FIGS. 1-4. For example, the timing diagram 500 illustrates timing for a reference resource, such as the reference slot 505, relative to a CSI reporting resource, such as the CSI reporting slot 510. A UE may include, in a CSI report to be transmitted via the CSI reporting resource, CSI measurements obtained before a reference time that is based on the reference resource. As described herein, the CSI report timing may be adjusted based on a duplexing type associated with the CSI reporting.

As described with reference to FIG. 4, the UE may obtain CSI based on measurements of reference signals received at the UE. In some cases, one or more CSI parameters that are included in a CSI report (e.g., a CQI) are calculated based on a hypothetical PDSCH transmission scheduled in a “CSI reference resource,” which may be defined by a wireless communications standard, such as the 3GPP standards. The reference slot 505 illustrated in FIG. 5 may represent an example of a CSI reference resource. For example, in a frequency domain, a CSI reference resource for a serving cell may be defined by a group of downlink physical resource blocks that correspond to a band to which derived CSI relates. In a time domain, the CSI reference resource may define a reference downlink slot number as a timing reference for determining the end of a measurement window for a CSI report (e.g., a CSI report may not include any channel and/or interference measurements obtained after the reference downlink slot number).

Further, the CSI reference resource may define various properties for the hypothetical PDSCH transmission used to calculate the CSI parameters (e.g., a reference signal overhead, bandwidth, and/or precoding, among other examples). For example, in cases where a UE is configured to report one or more CSI parameters (e.g., a CQI index, a PMI, an RI, or the like) based on a hypothetical PDSCH transmission in the CSI reference resource, the UE may assume, in some examples, that the first two symbols of the CSI reference resource are occupied by control signaling, the quantity of PDSCH and DMRS symbols is 12, a BWP SCS is the same as configured for PDSCH reception, a bandwidth is as configured for a corresponding CSI parameter (e.g., a corresponding CQI report), the CSI reference resource uses the cyclic prefix length and SCS configured for PDSCH reception, no resource elements are used by a primary synchronization signal, a secondary synchronization signal, or a physical broadcast channel, a redundancy version is zero, a ratio of a PDSCH energy per resource element (EPRE) to a CSI-RS EPRE has a defined value (e.g., given in 3GPP TS 38.214, Clause 5.2.2.3.1, for example), and/or that no resource elements (REs) are allocated to a non-zero-power (NZP) CSI-RS and/or a zero-power (ZP) CSI-RS.

However, in cases where a UE is configured to communicate in a full-duplexing mode, one or more assumptions regarding the CSI reference resource may not hold. For example, as described above, the UE may assume that the bandwidth of the CSI reference resource is the same as configured for a corresponding CSI parameter (e.g., for a corresponding CQI report), and may further assume that no REs are allocated for a ZP CSI-RS used for rate-matching. Accordingly, because a full-duplex mode (e.g., SBFD) may be associated with non-contiguous downlink frequency resources, there may be a need to adapt a CSI-RS resource configuration for full-duplex communication (e.g., because a portion of the bandwidth is not available for downlink). Some aspects herein may thereby relate to a CSI reference resource definition that may be based on one or more non-contiguous resource allocations that may be used for a PDSCH and/or a PUSCH in an SBFD slot, where a middle frequency region is used for uplink-only. That is, a full-duplex reference resource may be defined herein as a reference resource in full-duplex (e.g., SBFD) slots. The UE may assume that the bandwidth of the CSI reference resource may exclude resources corresponding to an uplink sub-band, which may be different than a bandwidth assumption for a half-duplex reference resource, where the UE may assume that the bandwidth is as configured for a corresponding CSI parameter.

In some cases, if the UE is scheduled for CSI reporting in an uplink slot n, which may be referred to as a CSI reporting slot 510 herein, the CSI reference resource in the time domain may be defined by a single downlink slot n−n_{CSI,ref}. In this example, n_{CSI,ref} may be referred to as or may represent a threshold time period 515 between the CSI reporting slot 510 and the reference slot 505. For periodic and semi-persistent CSI reporting, the value of n_{CSI,ref} may be based on one or more constants, the SCS configured for communications, and a quantity of reference signal resources that are configured for channel measurement. In some systems, if a single reference signal (e.g., CSI-RS or SSB) resource is configured for channel measurement, n_{CSI,ref} may be a smallest value that is greater than or equal to 4*2^{μ}^{_{DL}}, such that n−n_{CSI,ref} corresponds to a valid downlink slot. In this example, μ_{DL} may represent the SCS for downlink communications. If multiple reference signal (e.g., CSI-RS or SSB) resources are configured for channel measurement, n_{CSI,ref} may be a smallest value that is greater than or equal to 5*2^{μ}^{_{DL}}, such that n−n_{CSI,ref} corresponds to a valid downlink slot. In this example, where μ_{DL} may represent the SCS for downlink communications. Although constant values of four and five are shown in the example equations for deriving the reference slot 505, it is to be understood that any constant X and Y values may be utilized to derive the reference slot 505. That is, the reference slot 505 may be based on any constant values, a quantity of reference signal resources configured for channel measurement, and the SCS configured for downlink communications.

Techniques, systems, and devices described herein define different timing protocols for the reference resource used by the UE for CSI reporting based on a type of the CSI reporting that is performed. For example, the UE may perform one or more different types of CSI reporting, as described with reference to FIG. 4. Techniques described herein provide for the UE to select or determine (e.g., calculate, estimate) a different reference resource based on the type of CSI reporting. As described herein, to account for measurements of reference signals that are received by the UE via full-duplex slots (e.g., SBFD slots), the definition of the reference resource may be updated to include a reference slot that is either a half-duplex slot (e.g., a downlink slot) or a full-duplex slot (e.g., an SBFD slot).

For example, if the UE is scheduled for CSI reporting in an uplink slot n, which may be referred to as a CSI reporting slot 510 herein, the CSI reference resource in the time domain may be defined by a single downlink or full-duplex (e.g., SBFD) slot n−n_{CSI,ref}, which may be the reference slot 505 illustrated in FIG. 5. In this example, n_{CSI,ref} may be referred to as or may represent a threshold time period 515 between the CSI reporting slot 510 and the reference slot 505. For periodic and semi-persistent CSI reporting, the value of n_{CSI,ref} may be based on one or more constants, the SCS configured for communications, and a quantity of reference signal resources that are configured for channel measurement. In some systems, if a single reference signal (e.g., CSI-RS or SSB) resource is configured for channel measurement, n_{CSI,ref} may be a smallest value that is greater than or equal to 4*2^{μ}^{_{DL}}, such that n−n_{CSI,ref} corresponds to a valid downlink or full-duplex slot. In this example, μ_{DL} may represent the SCS for downlink communications. If multiple reference signal (e.g., CSI-RS or SSB) resources are configured for channel measurement, n_{CSI,ref} may be a smallest value that is greater than or equal to 5*2^{μ}^{_{DL}}, such that n−n_{CSI,ref} corresponds to a valid downlink or full-duplex slot. In this example, where μ_{DL} may represent the SCS for downlink communications. Although constant values of four and five are shown in the example equations for deriving the reference slot 505, it is to be understood that any constant X and Y values may be utilized to derive the reference slot 505. That is, the reference slot 505 may be based on any constant values, a quantity of reference signal resources configured for channel measurement, and the SCS configured for downlink communications.

In some examples, a same reference signal may be transmitted and/or received via both full-duplex and non-duplex resources (e.g., as in examples 405 and 415 illustrated in FIG. 4). As such, the reference resource type may be associated with a CSI reporting type, because the reference resource may depend on a duplexing type of the CSI report. Techniques described herein define a duplexing type for CSI reference resources. The duplexing type may be one of a half-duplexing type (e.g., non-SBFD) or a full-duplexing type (e.g., SBFD). A half-duplex reference resource may occur in half-duplex slots (e.g., downlink-only or uplink-only slots). A full-duplex reference resource may occur in full-duplex slots (e.g., SBFD-only slots).

If a UE is configured to transmit one or more CSI reports based on measurements of a single reference signal received via full-duplex and half-duplex resources, as described with reference to examples 405 and 415 in FIG. 4, the UE may determine a duplexing type for the reference resource based on a duplexing type for the CSI report. If the UE is configured to transmit two CSI reports, the duplexing type of each CSI report may be based on the CSI configuration. If the UE is configured to transmit a single CSI report, the duplexing type of the CSI report may be based on a slot type of a reference signal instance, as described with reference to FIG. 4. In some examples, the UE may select two reference resources, including a full-duplex reference resource for a full-duplex CSI report and a half-duplex reference resource for a half-duplex CSI report.

The timing protocols (e.g., requirements or parameters for determining the threshold time period 515) for a full-duplex reference resource may be different than timing protocols for a half-duplex reference resource. For example, the timing for a full-duplex reference resource may be relaxed as compared with timing for a half-duplex reference resource as the UE may process two or more downlink sub-bands separately. That is, in some examples, the threshold time period 515 may be longer if the reference slot 505 is a full-duplex slot than if the reference slot 505 is a half-duplex slot to provide more time for processing and CSI computation before the CSI reporting slot 510.

For example, if the UE is scheduled for CSI reporting in an uplink slot n, the CSI reference resource in the time domain may be defined by a single full-duplex (e.g., SBFD) slot n−n_{CSI,ref}, which may be the reference slot 505 illustrated in FIG. 5. In this example, n_{CSI,ref} may be referred to as or may represent a threshold time period 515 between the CSI reporting slot 510 and the reference slot 505. For periodic and semi-persistent CSI reporting, if a single reference signal (e.g., CSI-RS or SSB) resource is configured for channel measurement, n_{CSI,ref} may be a smallest value that is greater than or equal to X*2^{μ}^{_{DL}}, such that n−n_{CSI,ref} corresponds to a valid full-duplex slot. In this example, μ_{DL} may represent the SCS for downlink communications. If multiple reference signal (e.g., CSI-RS or SSB) resources are configured for channel measurement, n_{CSI,ref} may be a smallest value that is greater than or equal to Y*2^{μ}^{_{DL}}, such that n−n_{CSI,ref} corresponds to a valid full-duplex slot. In this example, the values of X and Y may be set to any value based on one or more parameters, such as a processing time associated with the UE, a latency associated with communications, or some other parameter. In some examples, the values of X and Y may be configured (e.g., pre-defined) at the UE during deployment or indicated to the UE via control signaling. That is, the reference slot 505 may be a full-duplex slot that occurs a time that is based on any constant values, a quantity of reference signal resources configured for channel measurement, and the SCS configured for downlink communications.

In some examples, the full-duplex CSI reference resource may be defined for CSI-RS and SSB. Such a definition may assume that SSBs are permitted in full-duplex slots. As such, the definition of the full-duplex CSI reference resource may specify the timing parameters for a valid full-duplex resource for CSI-RS or for SSB. In some other examples, the full-duplex CSI reference resource may be defined for CSI-RS and not for SSBs (e.g., CSI-RS only). This may apply in cases where, for example, SSBs may not be configured in full-duplex slots (e.g., SSBs may only be configured in downlink slots). If the full-duplex CSI reference resource is defined for CSI-RS and not for SSB, the definition may apply to a valid full-duplex resource that is allocated for CSI-RSs, but may exclude valid resources allocated for SSBs. For example, for periodic and semi-persistent CSI reporting, if a single CSI-RS resource is configured for channel measurement, n_{CSI,ref} may be a smallest value that is greater than or equal to X*2^{μ}^{_{DL}}, such that n−n_{CSI,ref} corresponds to a valid full-duplex CSI-RS slot. If multiple CSI-RS resources are configured for channel measurement, n_{CSI,ref} may be a smallest value that is greater than or equal to Y*2^{μ}^{_{DL}}, such that n−n_{CSI,ref} corresponds to a valid full-duplex CSI-RS slot. In this example, the values of X and Y may be set to any value based on one or more parameters, as described above. The full-duplex CSI reference resource described herein may additionally, or alternatively, be associated with a hypothetical PDSCH transmission that excludes frequency resources corresponding to an uplink sub-band and a guard-band (e.g., downlink-only resources).

The UE as described herein may thereby determine a reference slot 505 associated with CSI reporting in a CSI reporting slot 510 based on the reference slot 505 being an earliest valid slot of a same duplexing type as the CSI report that is at least the threshold time period 515 before the CSI reporting slot 510 in time. The threshold time period 515 may correspond to a quantity of slots, symbols, other resources, seconds, or some other time duration that is determined by a quantity of resources configured for channel measurement, an SCS for communications, a duplexing type of the reference resource (e.g., full-duplex or half-duplex) and one or more constant values, as described herein.

In some examples, if the UE is configured to transmit two CSI reports including a first CSI report for full-duplex CSI and a second CSI report for half-duplex CSI, the UE may transmit the CSI reports via two CSI reporting slots and the UE may select two reference slots or other resources. A first reference resource may be an earliest valid full-duplex resource that is at least a first threshold time period from the first CSI reporting slot for full-duplex reporting. A second reference resource may be an earliest valid half-duplex resource that is at least a second threshold time period from the second CSI reporting slot for half-duplex reporting. The first threshold time period in this example may be based on the first reference resource being of the full-duplex type and the second threshold time period may be based on the second resource being of the half-duplex type, in some examples (e.g., the first threshold time period may be extended as compared with the second threshold time period). Additionally, or alternatively, the first and second time periods may be of a same duration. The UE may transmit full-duplex CSI via the full-duplex CSI report in the first CSI reporting slot based on measurements of reference signals received before or during the first reference slot. The UE may transmit half-duplex CSI via the half-duplex CSI reporting in the second CSI reporting slot based on measurements of reference signals received before or during the second reference slot.

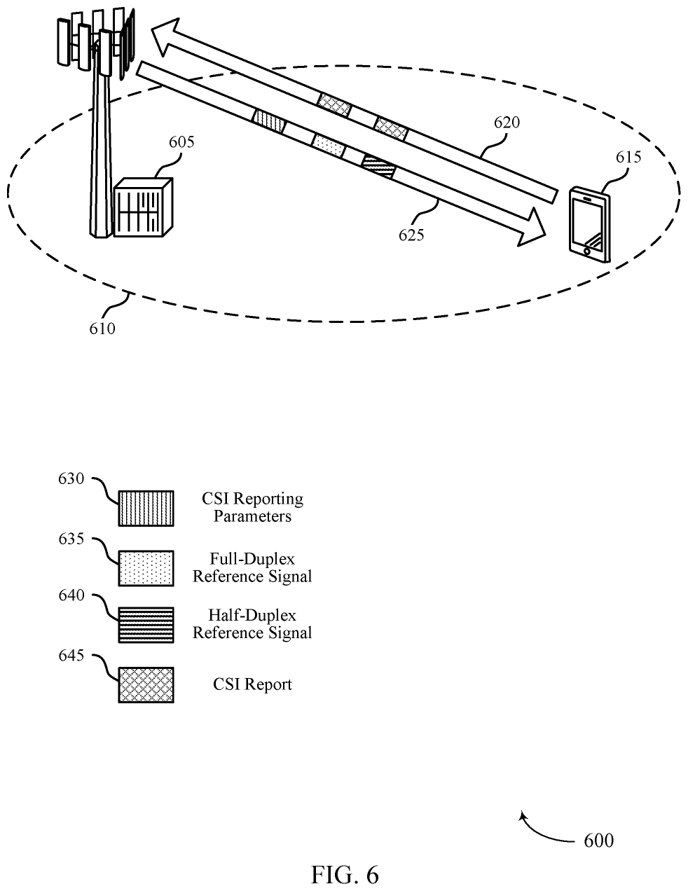

FIG. 6 shows an example of a wireless communications system 600 that supports reference resource configuration for full-duplex and half-duplex wireless communications in accordance with one or more aspects of the present disclosure. The wireless communications system 600 may implement or be implemented by aspects of the wireless communications system 100, the example full-duplexing deployments, the example CSI reporting schemes, and the timing diagram 500 as described with reference to FIGS. 1-5. For example, the wireless communications system 600 may include a network entity 605 and a UE 615, which may represent examples of a network entity and a UE as described with reference to FIGS. 1-5. The network entity 605 and the UE 615 may communicate within a geographic coverage area 610 and via one or more communication links 620 and 625. In this example, the network entity 605 may transmit one or more different types of reference signals to the UE 615 and the UE 615 may perform CSI reporting based on a duplexing type associated with the reference signals and a CSI reporting configuration for the UE 615.

The communication links 620 and 625 illustrated in FIG. 6 may be illustrated as uplink and downlink links, respectively, for clarity. However, it is to be understood that the communication links 620 and 625 may include any type of uplink, downlink, or full-duplex resources. Additionally, or alternatively, it is to be understood that the network entity 605 and the UE 615 may exchange any one or more of the signals described herein via any quantity of one or more communication links, including a single communication link comprising both uplink and downlink resources.

The network entity 605 and the UE 615 may communicate using full-duplex communications, half-duplex communications, or both. That is, the UE 615 may be a full-duplex-aware UE 615. The full-duplex communications may include SBFD, IBFD, or some other type of full-duplex communications. The half-duplex communications may include uplink or downlink communications. The network entity 605 and the UE 615 may communicate according to any one of the full-duplexing deployments described with reference to FIG. 3, or any other full-duplexing deployment not illustrated in FIG. 3.

In the wireless communications system 600, CSI may include one or more parameters that relate to properties associated with a wireless channel and/or represent how a signal propagates between the UE 615 and the network entity 605 based on the combined effect of scattering, fading, and/or power decay with distance. Accordingly, the network entity 605 may use CSI obtained by the UE 615 to adapt transmissions to current channel conditions, which may increase reliability and/or throughput in the wireless communications system 600.

CSI may be obtained based on one or more reference signal transmissions (e.g., CSI-RSs or SSBs) that may be used for downlink and/or uplink channel estimation. For example, in some aspects, a CSI-RS may carry information used for downlink channel estimation (e.g., downlink CSI acquisition), which the network entity 605 may use for scheduling, link adaptation, or beam management, among other examples. The network entity 605 may configure a CSI-RS for the UE 615, and the UE 615 may measure the configured CSI-RS. Based on the measurements, the UE 615 may perform channel estimation and may report channel estimation parameters to the network entity 605 (e.g., in a CSI report 645), such as a CQI, a PMI, a CRI, an LI, an RI, or an RSRP, among other examples. The network entity 605 may use the CSI report to select transmission parameters for downlink communications to the UE 615, such as a quantity of transmission layers (e.g., a rank), a precoding matrix (e.g., a precoder), an MCS, or a refined downlink beam (e.g., using a beam refinement procedure or a beam management procedure), among other examples.

The network entity 605 may transmit signaling that indicates one or more CSI parameters 630 for CSI reporting by the UE 615 (e.g., a CSI report configuration). The one or more CSI parameters may indicate parameters for half-duplex CSI reporting, full-duplex CSI reporting, or both. For example, the network entity 605 may configure the UE 615 to transmit a single CSI report 645 or two CSI reports 645, as described in further detail elsewhere herein, including with reference to FIG. 4.

The network entity 605 may subsequently transmit one or more reference signals to the UE 615. The reference signals may include a full-duplex reference signal 635, a half-duplex reference signal 640, or both. The reference signals may be CSI-RSs, SSBs, or some other type of reference signal. In some examples, the network entity 605 may transmit a full-duplex reference signal 635 via full-duplex resources and a half-duplex reference signal 640 via half-duplex resources. Additionally, or alternatively, the network entity 605 may transmit a single reference signal via one or more half-duplex resources (e.g., transmission occasions) and one or more full-duplex resources (e.g., transmission occasions).

The UE 615 may obtain measurements of the reference signals and determine (e.g., calculate or estimate) CSI information based on the reference signal measurements. Measuring the reference signals may include determining a reference resource for the CSI reporting. As described herein, the UE 615 may determine one or more reference resources based on a duplexing type associated with the CSI reporting. For example, the UE 615 may select a full-duplex reference resource, a half-duplex reference resource, or both, as described in further detail with reference to FIG. 5. The reference resource may be at least a threshold time period before a CSI reporting resource via which the UE 615 is scheduled to transmit the CSI report 645. The UE 615 may include CSI parameters in the CSI report 645 that are based on measurements obtained before or during the reference resource. The threshold time period may be adjusted based on the duplexing type. For example, a full-duplex reference resource may be a longer time period from the CSI reporting resource than a half-duplex reference resource to provide additional processing time.

The UE 615 may transmit one or more CSI reports 645 based on the measurements. In some examples, the UE 615 may transmit a first CSI report 645 that includes full-duplex CSI parameters based on measurements of a full-duplex reference signal 635 or based on measurements of a reference signal in full-duplex resources, and the UE 615 may transmit a second CSI report 645 that includes half-duplex CSI parameters based on measurements of a half-duplex reference signal 640 or based on measurements of a reference signal received via half-duplex resources. Additionally, or alternatively, the UE 615 may transmit a single CSI report 645 that includes either full-duplex CSI parameters or half-duplex CSI parameters.

In some examples described herein, if a duplexing type of the CSI report 645 is not indicated via the CSI reporting parameters 630 or the CSI reference resource, the UE 615 may determine the duplexing type for the CSI report 645 based on a duplexing type associated with resources via which a reference signal instance is received. For example, if the CSI report 645 includes CSI parameters based on measurements of a first instance of a reference signal received via a full-duplex slot, the UE 615 may transmit a full-duplex CSI report 645. In some examples, the UE 615 may transmit a first instance of the CSI report 645 that includes full-duplex CSI parameters and a second instance of the CSI report 645 that includes half-duplex CSI parameters, or vice versa.

The UE 615 described herein may thereby support full-duplex CSI reporting, half-duplex CSI reporting, or both. By determining a CSI reporting type and a timing for CSI reporting based on the techniques described herein, the UE 615 may support improved efficiency and reliability of the CSI reporting.

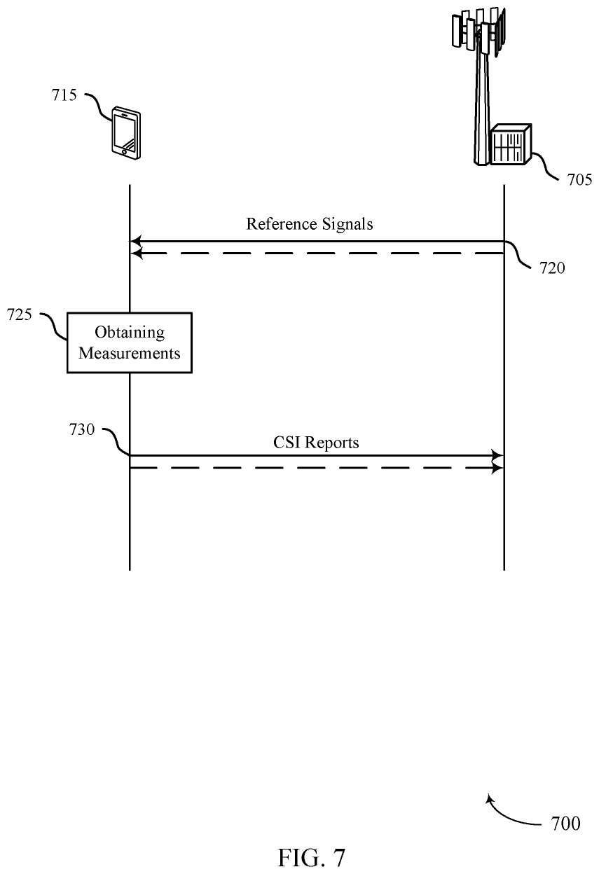

FIG. 7 shows an example of a process flow 700 that supports reference resource configuration for full-duplex and half-duplex wireless communications in accordance with one or more aspects of the present disclosure. The process flow 700 may implement or be implemented by aspects of FIGS. 1-7. For example, the process flow 700 illustrates communications between a network entity 705 and a UE 715, which may represent aspects of corresponding devices as described with reference to FIGS. 1-7. In some aspects, the UE 715 may adjust a timing for CSI reporting based on a duplexing mode associated with the CSI reporting.

In the following description of the process flow 700, the operations between the network entity 705 and the UE 715 may be performed in different orders or at different times. Some operations may also be left out of the process flow 700, or other operations may be added. Although the network entity 705 and the UE 715 are shown performing the operations of the process flow 700, some aspects of some operations may also be performed by one or more other wireless devices.

At 720, the network entity 705 may transmit one or more reference signals to the UE 715. The one or more reference signals may include full-duplex reference signals, half-duplex reference signals, or both. The one or more reference signals may include CSI-RSs, SSBs, or one or more other types of signals.

A reference signal may be considered full-duplex if the reference signal is transmitted via full-duplex resources. A reference signal may be considered half-duplex if the reference signal is transmitted via half-duplex resources. In some examples, the UE 715 may be configured to monitor two reference signal resources, which may correspond to or convey two reference signals. For example, the UE 715 may monitor for and receive a full-duplex reference signal and a half-duplex reference signal. In some examples, the UE 715 may be configured to monitor one reference signal resource, which may correspond to or convey one reference signal. The single reference signal may be transmitted via multiple transmission occasions that are in both full-duplex resources and half-duplex resources. Example reference signal resource configurations are described in further detail elsewhere herein, including with reference to FIG. 4.

At 725, the UE 715 may obtain measurements of the one or more reference signals. For example, the UE 715 may measure one or more parameters or metrics associated with the received reference signals. The UE 715 may calculate one or more CSI parameters to be included in a CSI report (e.g., a CQI, PMI, RI, or other CSI parameter) based on the measurements. In some examples, if the UE 715 is configured with two reference signal resources, the UE 715 may obtain a first measurement of a first reference signal received via full-duplex resources, or the UE 715 may obtain a second measurement of a second reference signal received via half-duplex resources, or the UE 715 may obtain both the first and second measurements. The UE 715 may calculate CSI parameters for full-duplex or half-duplex based on the first and second measurements, respectively. The UE 715 may include one or both of the full-duplex and half-duplex CSI parameters in one or two CSI reports based on a CSI reporting configuration.

In some other examples, if the UE 715 is configured with a single reference signal resource, the UE 715 may receive a single reference signal via full-duplex and half-duplex resources. The UE 715 may obtain a first measurement of the reference signal in the full-duplex resource(s), the UE 715 may obtain a second measurement of the reference signal in the half-duplex resource(s), or the UE 715 may obtain both the first and second measurements. The UE 715 may calculate CSI parameters for full-duplex or half-duplex based on the first and second measurements, respectively.

In some examples, the measurements of the one or more reference signals may be associated with one or more reference resources that are allocated for full-duplex communications, half-duplex communications, or both. For example, the UE 715 may calculate the CSI parameters, in some examples, based on a hypothetical PDSCH transmission scheduled in a reference resource. In a time domain, a reference resource may define a reference downlink slot number as a timing reference for determining the end of a measurement window for a CSI report (e.g., a CSI report may not include any channel and/or interference measurements obtained after the reference resource), as described in further detail elsewhere herein, including with reference to FIG. 5.

At 730, the UE 715 may transmit one or more CSI reports to the network entity 705. The UE 715 may transmit the one or more CSI reports at least a threshold time period after the one or more reference resources associated with the measurements. The one or more CSI reports may include one or more CSI parameters based on the measurements. The CSI reports may include a full-duplex CSI report, a half-duplex CSI report, or both. A full-duplex CSI report may include one or more full-duplex CSI parameters that are based on the first measurement of the full-duplex reference signal or of the reference signal in the full-duplex resources. A half-duplex CSI report may include one or more half-duplex CSI parameters that are based on the second measurement of the half-duplex reference signal or of the reference signal in the half-duplex resources.

If the UE 715 is configured to transmit two CSI reports, the UE 715 may transmit a first CSI report that includes full-duplex CSI parameters and a second CSI report that includes half-duplex CSI parameters. The UE 715 may transmit each of the first and second CSI reports via a respective CSI reporting resource. A first reference resource associated with the full-duplex CSI parameters may be at least a first threshold time period before a first CSI reporting resource via which the full-duplex CSI report is transmitted. The first threshold time period may be based on a quantity of reference signal resources configured for channel measurement (e.g., for full-duplex measurements), a duplexing type of the first reference resource, an SCS for communications, or any combination thereof, as described in further detail elsewhere herein, including with reference to FIG. 5. A second reference resource associated with the half-duplex CSI parameters may be at least a second threshold time period before a second CSI reporting resource via which the half-duplex CSI report is transmitted. The second threshold time period may be based on a quantity of reference signal resources configured for channel measurement (e.g., for half-duplex measurements), a duplexing type of the first reference resource, an SCS for communications, or any combination thereof, as described in further detail elsewhere herein, including with reference to FIG. 5. The first and second threshold time periods may be the same or different (e.g., the time period may be longer for full-duplex resources than half-duplex resources).

If the UE 715 is configured to transmit a single CSI report, the UE 715 may transmit a single CSI report that includes either full-duplex CSI parameters or half-duplex CSI parameters. The UE 715 may transmit the CSI report via a CSI reporting resource. The full-duplex CSI parameters may be associated with (e.g., measured or obtained in accordance with) a first reference resource, which may be a full-duplex resource. The first reference resource may be an earliest valid full-duplex resource that is at least a first threshold time period before the CSI reporting resource. The half-duplex CSI parameters may be associated with (e.g., measured or obtained in accordance with) a second reference resource, which may be a half-duplex resource. The second reference resource may be an earliest valid half-duplex resource that is at least a second threshold time period before the CSI reporting resource. The first and second threshold time periods may be based on the duplexing type of the first and second reference resources and may be of a same duration or different durations, as described in further detail elsewhere herein, including with reference to FIG. 5. The UE 715 may utilize the first reference resource if the CSI report is a full-duplex CSI report or the second reference resource if the CSI report is a half-duplex CSI report. In some examples, the first reference resource (e.g., a full-duplex resource) may be defined for CSI-RS transmissions and not SSB transmissions, or the first reference resource may be defined for both CSI-RS and SSB transmissions.

In some examples, the UE 715 may transmit a second instance of the CSI report. For example, if the first instance of the CSI report conveys full-duplex CSI parameters, the UE 715 may transmit a second instance of the CSI report that conveys half-duplex CSI parameters, or vice versa. That is, the CSI report configuration for the UE 715 may indicate that both full-duplex and half-duplex CSI may be generated and send in different instances of a CSI report.

The UE 715 may thereby select (e.g., determine, estimate, or calculate) an appropriate reference resource to use for CSI reporting based on a type of the CSI reporting, which may provide for the UE 715 to perform accurate and reliable CSI measurements and CSI reporting with relatively low latency.

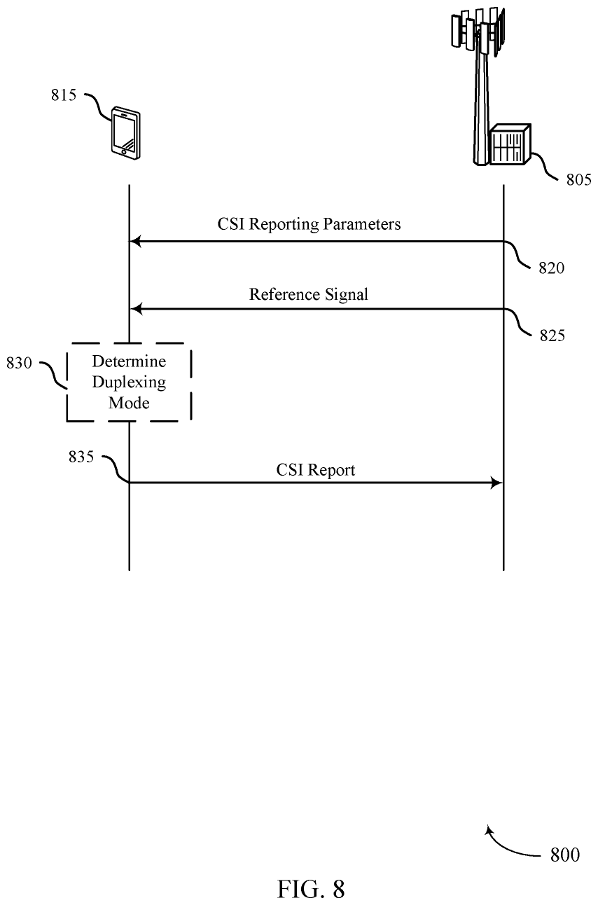

FIG. 8 shows an example of a process flow 800 that supports reference resource configuration for full-duplex and half-duplex wireless communications in accordance with one or more aspects of the present disclosure. The process flow 800 may implement or be implemented by aspects of FIGS. 1-7. For example, the process flow 800 illustrates communications between a network entity 805 and a UE 815, which may represent aspects of corresponding devices as described with reference to FIGS. 1-7. In some aspects, the UE 815 may adjust a timing for CSI reporting based on a duplexing mode associated with the CSI reporting.

In the following description of the process flow 800, the operations between the network entity 805 and the UE 815 may be performed in different orders or at different times. Some operations may also be left out of the process flow 800, or other operations may be added. Although the network entity 805 and the UE 815 are shown performing the operations of the process flow 800, some aspects of some operations may also be performed by one or more other wireless devices.

At 820, the network entity 805 may transmit an indication of one or more parameters for half-duplex CSI reporting, full-duplex CSI reporting, or both. The indication may represent an example of a CSI report configuration, in some examples. The one or more parameters may indicate one or more reference resources for the CSI reporting. The reference resources may be half-duplex resources, full-duplex resources, or both.

At 825, the network entity 805 may transmit a reference signal to the UE 815 via a TTI. The reference signal may be a CSI-RS or an SSB, in some examples. The TTI (e.g., a slot, a symbol, or some other time interval) may include half-duplex resource or full-duplex resources. In some examples, the reference signal may represent an instance or a portion of a reference signal that is received via the TTI. For example, the reference resources may be included in the TTI, but one or more other portions of the reference signal may be received via other TTIs. The TTI may be associated with a single resource duplexing type (e.g., either half-duplex resources or full-duplex resources).

At 830, in some examples, the UE 815 may determine a duplexing mode associated with the CSI report to be transmitted by the UE 815. The one or more parameters may, in some examples, indicate two duplexing modes for CSI reporting, including half-duplex and full-duplex. As such, the UE 815 may determine the duplexing mode based on a type (e.g., a slot type) of the associated reference resources. For example, the UE 815 may determine whether the TTI via which the instance of the reference signal was received is a half-duplex TTI, including resources allocated for half-duplex communications, or a full-duplex TTI, including resources allocated for full-duplex communications. The UE 815 may determine that the duplexing mode of the CSI report is the same as the type of the TTI that includes the reference resources.

The reference resources may thereby be either half-duplex reference resources (e.g., non-SBFD reference resources), which may be defined in downlink slots, or full-duplex reference resources (e.g., SBFD reference resources), which may be defined in full-duplex slots. The half-duplex reference resources may represent a hypothetical PDSCH with resource elements that may be defined based on a corresponding CSI parameter. The full-duplex reference resources may represent hypothetical PDSCH with resource elements that may exclude uplink resources, guard-band resources, or both (e.g., a portion of frequency resources allocated for uplink and a guard-band may be excluded).

At 835, the UE 815 may transmit a CSI report to the network entity 805. The CSI report may be transmitted in accordance with the parameters indicated via the CSI report configuration and a duplexing mode. The duplexing mode may be one of the half-duplexing mode or the full-duplexing mode based on the type of the TTI. In some examples, the UE 815 may transmit a first instance of the CSI report that includes CSI parameters associated with a full-duplexing mode, and the UE 815 may subsequently transmit a second instance of the CSI report that includes CSI parameters associated with a half-duplexing mode, or vice versa.

The UE 815 described herein may thereby utilize a type of a TTI via which an instance of a reference signal is received to determine a duplexing mode for transmitting a CSI report. Such techniques may apply in scenarios in which the UE 815 receives an indication of multiple CSI reporting types and receives a single reference signal. In such cases, the UE 815 may be unable to determine the duplexing mode for CSI reporting directly from the CSI reporting configuration or the reference signals, and the TTI type may improve throughput and reliability.

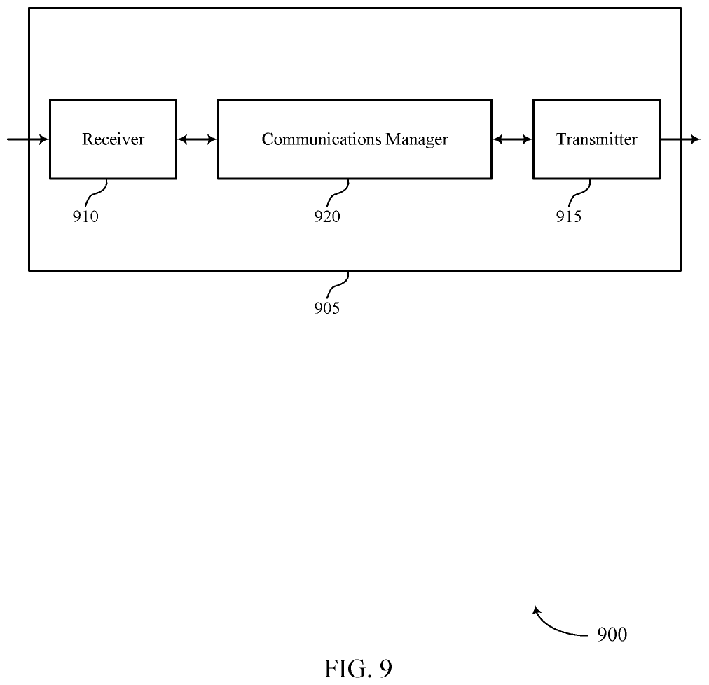

FIG. 9 shows a block diagram 900 of a device 905 that supports reference resource configuration for full-duplex and half-duplex wireless communications in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to reference resource configuration for full-duplex and half-duplex wireless communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to reference resource configuration for full-duplex and half-duplex wireless communications). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of reference resource configuration for full-duplex and half-duplex wireless communications as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. For example, the communications manager 920 is capable of, configured to, or operable to support a means for receiving one or more reference signals including one or more full-duplex reference signals, one or more half-duplex reference signals, or both. The communications manager 920 is capable of, configured to, or operable to support a means for obtaining measurements of the one or more reference signals, the measurements associated with one or more reference resources that are associated with full-duplex communications, half-duplex communications, or both. The communications manager 920 is capable of, configured to, or operable to support a means for transmitting, at least a threshold time period after the one or more reference resources, one or more CSI reports based on the measurements of the one or more reference signals, where the threshold time period is based on a duplexing mode associated with the one or more CSI reports.

Additionally, or alternatively, the communications manager 920 may support wireless communication at a UE in accordance with examples as disclosed herein. For example, the communications manager 920 is capable of, configured to, or operable to support a means for receiving an indication of one or more parameters for half-duplex CSI reporting, full-duplex CSI reporting, or both, the one or more parameters indicating one or more reference resources that include half-duplex reference resources, full-duplex reference resources, or both. The communications manager 920 is capable of, configured to, or operable to support a means for receiving, via a TTI, a reference signal, the TTI including one of the half-duplex reference resources or the full-duplex reference resources. The communications manager 920 is capable of, configured to, or operable to support a means for transmitting, in accordance with the one or more parameters, a CSI report according to a duplexing mode, where the duplexing mode includes one of a half-duplexing mode based on the TTI including the half-duplex reference resources or a full-duplexing mode based on the TTI including the full-duplex reference resources.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, and more efficient utilization of communication resources, among other possibilities.

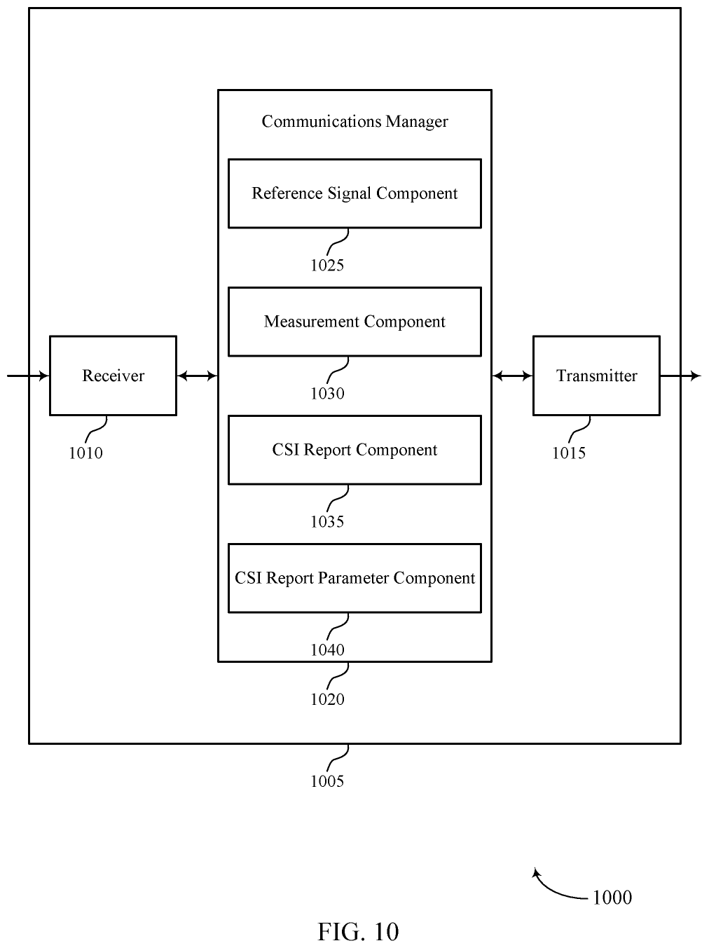

FIG. 10 shows a block diagram 1000 of a device 1005 that supports reference resource configuration for full-duplex and half-duplex wireless communications in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to reference resource configuration for full-duplex and half-duplex wireless communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to reference resource configuration for full-duplex and half-duplex wireless communications). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of reference resource configuration for full-duplex and half-duplex wireless communications as described herein. For example, the communications manager 1020 may include a reference signal component 1025, a measurement component 1030, a CSI report component 1035, a CSI report parameter component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples as disclosed herein. The reference signal component 1025 is capable of, configured to, or operable to support a means for receiving one or more reference signals including one or more full-duplex reference signals, one or more half-duplex reference signals, or both. The measurement component 1030 is capable of, configured to, or operable to support a means for obtaining measurements of the one or more reference signals, the measurements associated with one or more reference resources that are associated with full-duplex communications, half-duplex communications, or both. The CSI report component 1035 is capable of, configured to, or operable to support a means for transmitting, at least a threshold time period after the one or more reference resources, one or more CSI reports based on the measurements of the one or more reference signals, where the threshold time period is based on a duplexing mode associated with the one or more CSI reports.

Additionally, or alternatively, the communications manager 1020 may support wireless communication at a UE in accordance with examples as disclosed herein. The CSI report parameter component 1040 is capable of, configured to, or operable to support a means for receiving an indication of one or more parameters for half-duplex CSI reporting, full-duplex CSI reporting, or both, the one or more parameters indicating one or more reference resources that include half-duplex reference resources, full-duplex reference resources, or both. The reference signal component 1025 is capable of, configured to, or operable to support a means for receiving, via a TTI, a reference signal, the TTI including one of the half-duplex reference resources or the full-duplex reference resources. The CSI report component 1035 is capable of, configured to, or operable to support a means for transmitting, in accordance with the one or more parameters, a CSI report according to a duplexing mode, where the duplexing mode includes one of a half-duplexing mode based on the TTI including the half-duplex reference resources or a full-duplexing mode based on the TTI including the full-duplex reference resources.

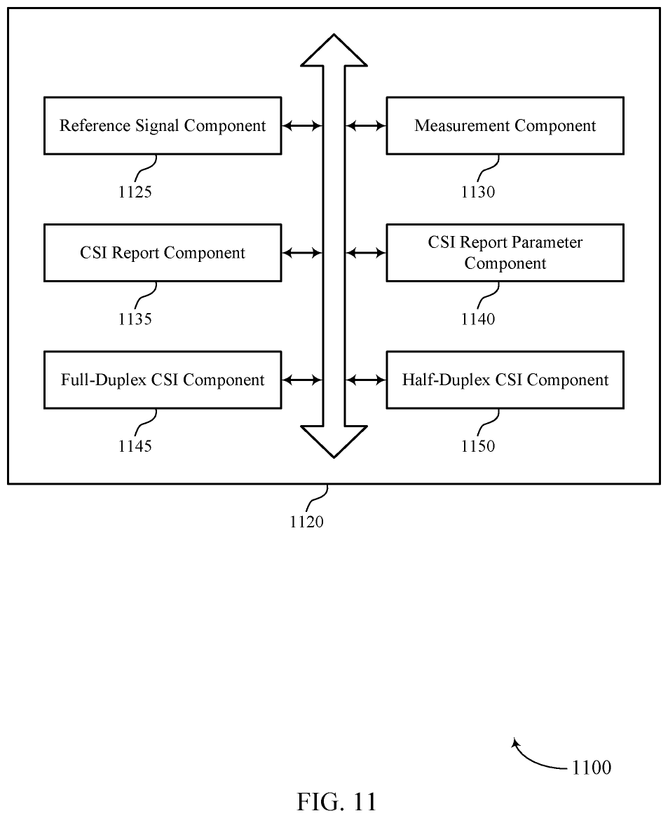

FIG. 11 shows a block diagram 1100 of a communications manager 1120 that supports reference resource configuration for full-duplex and half-duplex wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of reference resource configuration for full-duplex and half-duplex wireless communications as described herein. For example, the communications manager 1120 may include a reference signal component 1125, a measurement component 1130, a CSI report component 1135, a CSI report parameter component 1140, a full-duplex CSI component 1145, a half-duplex CSI component 1150, or any combination thereof. Each of these components may communicate, directly or indirectly, with one another (e.g., via one or more buses).

Additionally, or alternatively, the communications manager 1120 may support wireless communication at a UE in accordance with examples as disclosed herein. The reference signal component 1125 is capable of, configured to, or operable to support a means for receiving one or more reference signals including one or more full-duplex reference signals, one or more half-duplex reference signals, or both. The measurement component 1130 is capable of, configured to, or operable to support a means for obtaining measurements of the one or more reference signals, the measurements associated with one or more reference resources that are associated with full-duplex communications, half-duplex communications, or both. The CSI report component 1135 is capable of, configured to, or operable to support a means for transmitting, at least a threshold time period after the one or more reference resources, one or more CSI reports based on the measurements of the one or more reference signals, where the threshold time period is based on a duplexing mode associated with the one or more CSI reports.

In some examples, the one or more reference signals may include a full-duplex reference signal and a half-duplex reference signal. In some examples, to support obtaining the measurements of the one or more reference signals, the full-duplex CSI component 1145 is capable of, configured to, or operable to support a means for obtaining a first measurement of the full-duplex reference signal based on a first reference resource, where the first reference resource includes a resource that is associated with full-duplex CSI computation and that is at least a first threshold time period before a first CSI reporting resource for transmission of a first CSI report of the one or more CSI reports, the first CSI report associated with a full-duplexing mode. In some examples, to support obtaining the measurements of the one or more reference signals, the half-duplex CSI component 1150 is capable of, configured to, or operable to support a means for obtaining a second measurement of the half-duplex reference signal based on a second reference resource, where the second reference resource includes a resource that is associated with half-duplex CSI computation and that is at least a second threshold time period before a second CSI reporting resource for transmission of a second CSI report of the one or more CSI reports, the second CSI report associated with a half-duplexing mode. In some examples, to support obtaining the measurements of the one or more reference signals, the full-duplex CSI component 1145 is capable of, configured to, or operable to support a means for both.

In some examples, to support transmitting the one or more CSI reports, the full-duplex CSI component 1145 is capable of, configured to, or operable to support a means for transmitting, via the first CSI reporting resource, the first CSI report including one or more full-duplex CSI parameters that are based on the first measurement of the full-duplex reference signal. In some examples, to support transmitting the one or more CSI reports, the half-duplex CSI component 1150 is capable of, configured to, or operable to support a means for transmitting, via the second CSI reporting resource, the second CSI report including one or more half-duplex CSI parameters that are based on the second measurement of the half-duplex reference signal.

In some examples, to support transmitting the one or more CSI reports, the CSI report component 1135 is capable of, configured to, or operable to support a means for transmitting, via one of the first CSI reporting resource or the second CSI reporting resource, a single CSI report including one or more CSI parameters that are either based on the first measurement of the full-duplex reference signal or based on the second measurement of the half-duplex reference signal.

In some examples, the first threshold time period is based on the first reference resource including the resource that is associated with full-duplex CSI computation and on a quantity of reference signal resources for channel measurements by the UE. In some examples, the second threshold time period is based on the second reference resource including the resource that is associated with half-duplex CSI computation and on the quantity of reference signal resources for the channel measurements by the UE.

In some examples, the one or more reference signals include a reference signal received via one or more full-duplex resources, via one or more half-duplex resources, or both, and, to support obtaining the measurements of the reference signal, the full-duplex CSI component 1145 is capable of, configured to, or operable to support a means for obtaining a first measurement of the reference signal in the one or more full-duplex resources, where a first reference resource for the first measurement includes a resource that is associated with full-duplex CSI computation and that is at least a first threshold time period before a first CSI reporting resource for transmission of a first CSI report of the one or more CSI reports, the first CSI report associated with a full-duplexing mode. In some examples, to support obtaining the measurements of the reference signal, the half-duplex CSI component 1150 is capable of, configured to, or operable to support a means for obtaining a second measurement of the reference signal in the one or more half-duplex resources, where a second reference resource for the second measurement includes a resource that is associated with half-duplex CSI computation and that is at least a second threshold time period before a second CSI reporting resource for transmission of a second CSI report of the one or more CSI reports, the second CSI report associated with a half-duplexing mode. In some examples, to support obtaining the measurements of the reference signal, the full-duplex CSI component 1145 is capable of, configured to, or operable to support a means for both.

In some examples, a first duration of the first threshold time period is based on the first reference resource being associated with the full-duplex CSI computation and on a quantity of reference signal resources for channel measurements by the UE. In some examples, a second duration of the second threshold time period is based on the second reference resource being associated with the half-duplex CSI computation and on the quantity of reference signal resources for channel measurements by the UE. In some examples, the second duration is different than the first duration.

In some examples, the first reference resource is associated with one or more CSI-RSs. In some examples, the first reference resource is associated with one or more CSI-RSs and one or more SSBs.

In some examples, to support transmitting the one or more CSI reports, the full-duplex CSI component 1145 is capable of, configured to, or operable to support a means for transmitting, via the first CSI reporting resource, the first CSI report including one or more full-duplex CSI parameters that are based on the first measurement of the reference signal in the one or more full-duplex resources. In some examples, to support transmitting the one or more CSI reports, the half-duplex CSI component 1150 is capable of, configured to, or operable to support a means for transmitting, via the second CSI reporting resource, the second CSI report including one or more half-duplex CSI parameters that are based on the second measurement of the reference signal in the one or more half-duplex resources.

In some examples, to support transmitting the one or more CSI reports, the CSI report component 1135 is capable of, configured to, or operable to support a means for transmitting, via one of the first CSI reporting resource or the second CSI reporting resource, a CSI report including either one or more full-duplex CSI parameters that are based on the first measurement of the reference signal in the one or more full-duplex resources or one or more half-duplex CSI parameters that are based on the second measurement of the reference signal in the one or more half-duplex resources.

Additionally, or alternatively, the communications manager 1120 may support wireless communication at a UE in accordance with examples as disclosed herein. The CSI report parameter component 1140 is capable of, configured to, or operable to support a means for receiving an indication of one or more parameters for half-duplex CSI reporting, full-duplex CSI reporting, or both, the one or more parameters indicating one or more reference resources that include half-duplex reference resources, full-duplex reference resources, or both. In some examples, the reference signal component 1125 is capable of, configured to, or operable to support a means for receiving, via a TTI, a reference signal, the TTI including one of the half-duplex reference resources or the full-duplex reference resources. In some examples, the CSI report component 1135 is capable of, configured to, or operable to support a means for transmitting, in accordance with the one or more parameters, a CSI report according to a duplexing mode, where the duplexing mode includes one of a half-duplexing mode based on the TTI including the half-duplex reference resources or a full-duplexing mode based on the TTI including the full-duplex reference resources.

In some examples, the measurement component 1130 is capable of, configured to, or operable to support a means for obtaining measurements of the reference signal, the measurements associated with a reference resource that is associated with half-duplex CSI computation based on the TTI including the half-duplex reference resources, where the CSI report is transmitted according to the half-duplexing mode.

In some examples, the measurement component 1130 is capable of, configured to, or operable to support a means for obtaining measurements of the reference signal, the measurements associated with a reference resource that is associated with full-duplex CSI computation based on the TTI including the full-duplex reference resources, where the CSI report is transmitted according to the full-duplexing mode.

In some examples, the reference resource includes one or more downlink resources and is exclusive of uplink resources based on the reference resource being associated with the full-duplex CSI computation.

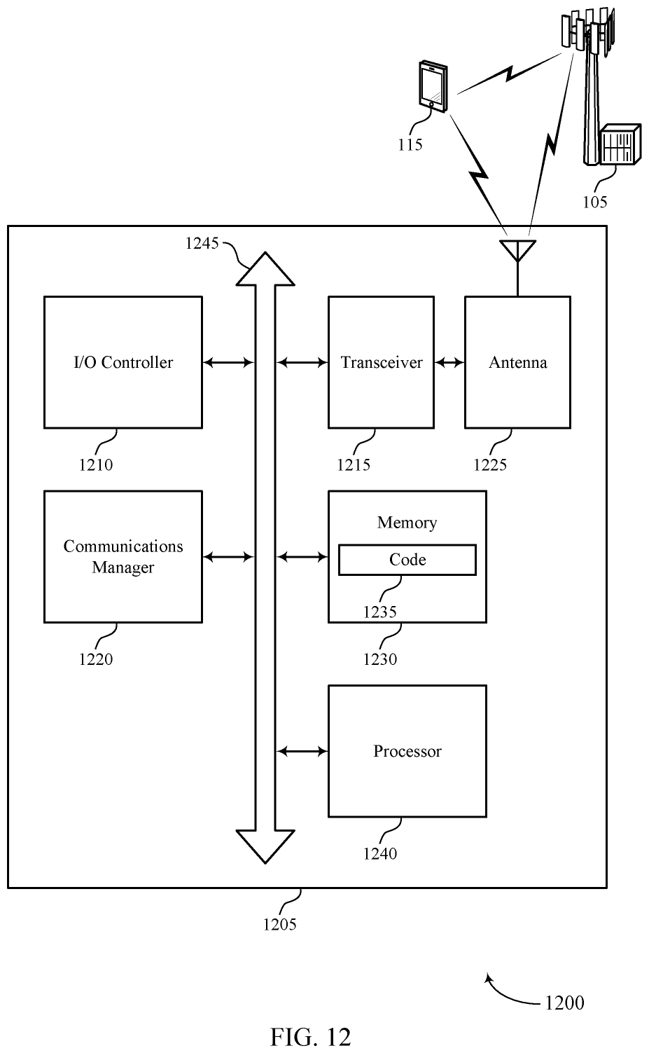

FIG. 12 shows a diagram of a system 1200 including a device 1205 that supports reference resource configuration for full-duplex and half-duplex wireless communications in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting reference resource configuration for full-duplex and half-duplex wireless communications). For example, the device 1205 or a component of the device 1205 may include a processor 1240 and memory 1230 coupled with or to the processor 1240, the processor 1240 and memory 1230 configured to perform various functions described herein.

Additionally, or alternatively, the communications manager 1220 may support wireless communication at a UE in accordance with examples as disclosed herein. For example, the communications manager 1220 is capable of, configured to, or operable to support a means for receiving one or more reference signals including one or more full-duplex reference signals, one or more half-duplex reference signals, or both. The communications manager 1220 is capable of, configured to, or operable to support a means for obtaining measurements of the one or more reference signals, the measurements associated with one or more reference resources that are associated with full-duplex communications, half-duplex communications, or both. The communications manager 1220 is capable of, configured to, or operable to support a means for transmitting, at least a threshold time period after the one or more reference resources, one or more CSI reports based on the measurements of the one or more reference signals, where the threshold time period is based on a duplexing mode associated with the one or more CSI reports.

Additionally, or alternatively, the communications manager 1220 may support wireless communication at a UE in accordance with examples as disclosed herein. For example, the communications manager 1220 is capable of, configured to, or operable to support a means for receiving an indication of one or more parameters for half-duplex CSI reporting, full-duplex CSI reporting, or both, the one or more parameters indicating one or more reference resources that include half-duplex reference resources, full-duplex reference resources, or both. The communications manager 1220 is capable of, configured to, or operable to support a means for receiving, via a TTI, a reference signal, the TTI including one of the half-duplex reference resources or the full-duplex reference resources. The communications manager 1220 is capable of, configured to, or operable to support a means for transmitting, in accordance with the one or more parameters, a CSI report according to a duplexing mode, where the duplexing mode includes one of a half-duplexing mode based on the TTI including the half-duplex reference resources or a full-duplexing mode based on the TTI including the full-duplex reference resources.

By including or configuring the communications manager 1220 in accordance with examples as described herein, the device 1205 may support techniques for improved communication reliability, reduced latency, reduced power consumption, more efficient utilization of communication resources, and improved coordination between devices, among other possibilities.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of reference resource configuration for full-duplex and half-duplex wireless communications as described herein, or the processor 1240 and the memory 1230 may be otherwise configured to perform or support such operations.

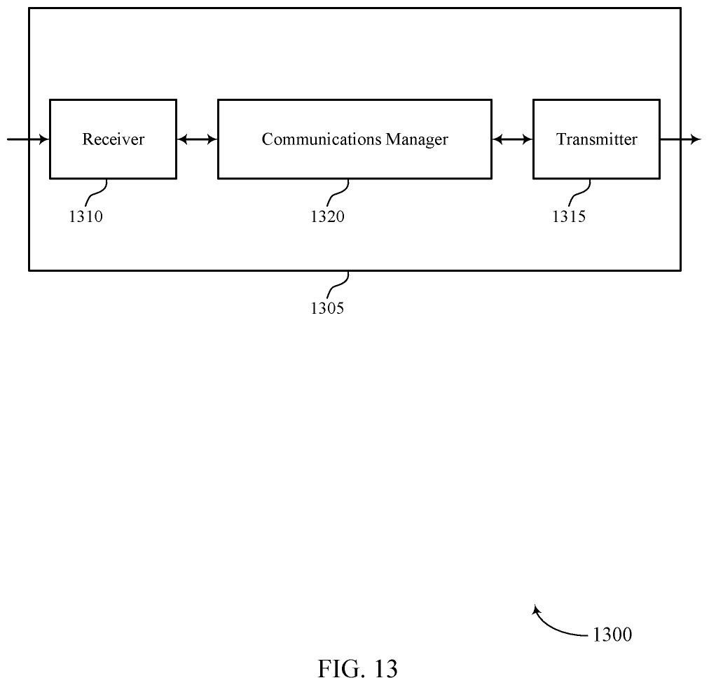

FIG. 13 shows a block diagram 1300 of a device 1305 that supports reference resource configuration for full-duplex and half-duplex wireless communications in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of reference resource configuration for full-duplex and half-duplex wireless communications as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

Additionally, or alternatively, the communications manager 1320 may support wireless communication at a network entity in accordance with examples as disclosed herein. For example, the communications manager 1320 is capable of, configured to, or operable to support a means for transmitting one or more reference signals including one or more full-duplex reference signals, one or more half-duplex reference signals, or both. The communications manager 1320 is capable of, configured to, or operable to support a means for receiving, at least a threshold time period after one or more reference resources, one or more CSI reports based on measurements of the one or more reference signals, the measurements associated with the one or more reference resources that are associated with full-duplex communications, half-duplex communications, or both, where the threshold time period is based on a duplexing mode associated with the one or more CSI reports.

Additionally, or alternatively, the communications manager 1320 may support wireless communication at a network entity in accordance with examples as disclosed herein. For example, the communications manager 1320 is capable of, configured to, or operable to support a means for transmitting an indication of one or more parameters for half-duplex CSI reporting, full-duplex CSI reporting, or both, the one or more parameters indicating one or more reference resources that include half-duplex reference resources, full-duplex reference resources, or both. The communications manager 1320 is capable of, configured to, or operable to support a means for transmitting, via a TTI, a reference signal, the TTI including one of the half-duplex reference resources or the full-duplex reference resources. The communications manager 1320 is capable of, configured to, or operable to support a means for receiving a CSI report associated with a duplexing mode, where the duplexing mode includes one of a half-duplexing mode based on the TTI including the half-duplex reference resources or a full-duplexing mode based on the TTI including the full-duplex reference resources.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced processing, reduced power consumption, and more efficient utilization of communication resources, among other possibilities.

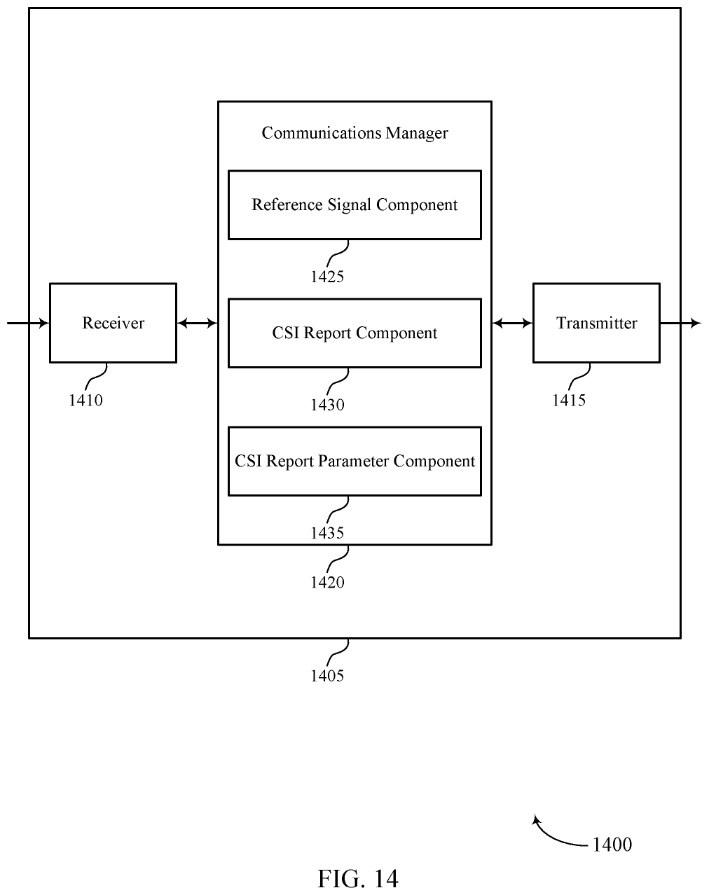

FIG. 14 shows a block diagram 1400 of a device 1405 that supports reference resource configuration for full-duplex and half-duplex wireless communications in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of reference resource configuration for full-duplex and half-duplex wireless communications as described herein. For example, the communications manager 1420 may include a reference signal component 1425, a CSI report component 1430, a CSI report parameter component 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a network entity in accordance with examples as disclosed herein. The reference signal component 1425 is capable of, configured to, or operable to support a means for transmitting one or more reference signals including one or more full-duplex reference signals, one or more half-duplex reference signals, or both. The CSI report component 1430 is capable of, configured to, or operable to support a means for receiving, at least a threshold time period after one or more reference resources, one or more CSI reports based on measurements of the one or more reference signals, the measurements associated with the one or more reference resources that are associated with full-duplex communications, half-duplex communications, or both, where the threshold time period is based on a duplexing mode associated with the one or more CSI reports.

Additionally, or alternatively, the communications manager 1420 may support wireless communication at a network entity in accordance with examples as disclosed herein. The CSI report parameter component 1435 is capable of, configured to, or operable to support a means for transmitting an indication of one or more parameters for half-duplex CSI reporting, full-duplex CSI reporting, or both, the one or more parameters indicating one or more reference resources that include half-duplex reference resources, full-duplex reference resources, or both. The reference signal component 1425 is capable of, configured to, or operable to support a means for transmitting, via a TTI, a reference signal, the TTI including one of the half-duplex reference resources or the full-duplex reference resources. The CSI report component 1430 is capable of, configured to, or operable to support a means for receiving a CSI report associated with a duplexing mode, where the duplexing mode includes one of a half-duplexing mode based on the TTI including the half-duplex reference resources or a full-duplexing mode based on the TTI including the full-duplex reference resources.

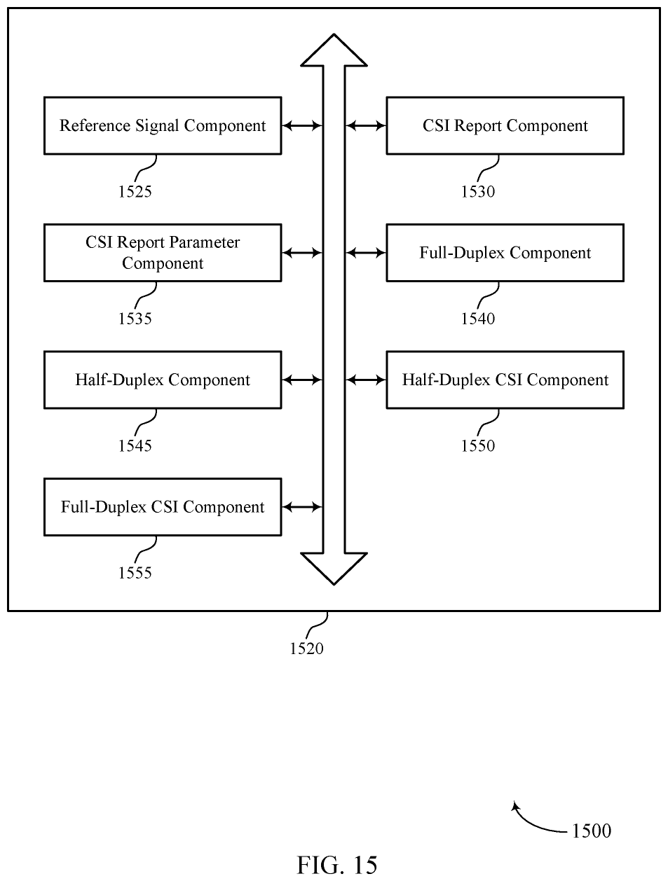

FIG. 15 shows a block diagram 1500 of a communications manager 1520 that supports reference resource configuration for full-duplex and half-duplex wireless communications in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of reference resource configuration for full-duplex and half-duplex wireless communications as described herein. For example, the communications manager 1520 may include a reference signal component 1525, a CSI report component 1530, a CSI report parameter component 1535, a full-duplex component 1540, a half-duplex component 1545, a half-duplex CSI component 1550, a full-duplex CSI component 1555, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1520 may support wireless communication at a network entity in accordance with examples as disclosed herein. The reference signal component 1525 is capable of, configured to, or operable to support a means for transmitting one or more reference signals including one or more full-duplex reference signals, one or more half-duplex reference signals, or both. The CSI report component 1530 is capable of, configured to, or operable to support a means for receiving, at least a threshold time period after one or more reference resources, one or more CSI reports based on measurements of the one or more reference signals, the measurements associated with the one or more reference resources that are associated with full-duplex communications, half-duplex communications, or both, where the threshold time period is based on a duplexing mode associated with the one or more CSI reports.

In some examples, to support transmitting the one or more reference signals, the full-duplex component 1540 is capable of, configured to, or operable to support a means for transmitting a full-duplex reference signal. In some examples, to support transmitting the one or more reference signals, the half-duplex component 1545 is capable of, configured to, or operable to support a means for transmitting a half-duplex reference signal.

In some examples, to support receiving the one or more CSI reports, the full-duplex CSI component 1555 is capable of, configured to, or operable to support a means for receiving, via a first CSI reporting resource, a first CSI report including one or more full-duplex CSI parameters that are based on the full-duplex reference signal, where the first CSI reporting resource is at least a first threshold time period after a first reference resource associated with the full-duplex reference signal. In some examples, to support receiving the one or more CSI reports, the half-duplex CSI component 1550 is capable of, configured to, or operable to support a means for receiving, via a second CSI reporting resource, a second CSI report including one or more half-duplex CSI parameters that are based on the half-duplex reference signal, where the second CSI reporting resource is at least a second threshold time period after a second reference resource associated with the half-duplex reference signal.

In some examples, to support receiving the one or more CSI reports, the CSI report component 1530 is capable of, configured to, or operable to support a means for receiving a single CSI report including one or more CSI parameters that are either based on the full-duplex reference signal or based on the half-duplex reference signal.

In some examples, to support transmitting the one or more reference signals, the reference signal component 1525 is capable of, configured to, or operable to support a means for transmitting a reference signal via one or more full-duplex resources, one or more half-duplex resources, or both.

In some examples, to support receiving the one or more CSI reports, the full-duplex CSI component 1555 is capable of, configured to, or operable to support a means for receiving, via a first CSI reporting resource, a first CSI report including one or more full-duplex CSI parameters that are based on the reference signal transmitted via the one or more full-duplex resources, where the first CSI reporting resource is at least a first threshold time period after a first reference resource associated with the one or more full-duplex resources. In some examples, to support receiving the one or more CSI reports, the half-duplex CSI component 1550 is capable of, configured to, or operable to support a means for receiving, via a second CSI reporting resource, a second CSI report including one or more half-duplex CSI parameters that are based on the reference signal transmitted via the one or more half-duplex resources, where the second CSI reporting resource is at least a second threshold time period after a second reference resource associated with the one or more half-duplex resources.

In some examples, the first reference resource is associated with one or more CSI-RSs. In some examples, the first reference resource is associated with one or more CSI-RSs and one or more SSBs.

In some examples, to support receiving the one or more CSI reports, the CSI report component 1530 is capable of, configured to, or operable to support a means for receiving, via a CSI reporting resource, a CSI report including either one or more full-duplex CSI parameters that are based on the reference signal transmitted in the one or more full-duplex resources or one or more half-duplex CSI parameters that are based on the reference signal transmitted in the one or more half-duplex resources.

Additionally, or alternatively, the communications manager 1520 may support wireless communication at a network entity in accordance with examples as disclosed herein. The CSI report parameter component 1535 is capable of, configured to, or operable to support a means for transmitting an indication of one or more parameters for half-duplex CSI reporting, full-duplex CSI reporting, or both, the one or more parameters indicating one or more reference resources that include half-duplex reference resources, full-duplex reference resources, or both. In some examples, the reference signal component 1525 is capable of, configured to, or operable to support a means for transmitting, via a TTI, a reference signal, the TTI including one of the half-duplex reference resources or the full-duplex reference resources. In some examples, the CSI report component 1530 is capable of, configured to, or operable to support a means for receiving a CSI report associated with a duplexing mode, where the duplexing mode includes one of a half-duplexing mode based on the TTI including the half-duplex reference resources or a full-duplexing mode based on the TTI including the full-duplex reference resources.

In some examples, to support receiving the CSI report, the half-duplex CSI component 1550 is capable of, configured to, or operable to support a means for receiving the CSI report according to the half-duplexing mode based on the TTI including the half-duplex reference resources, where a reference resource associated with the CSI report includes a half-duplex reference resource.

In some examples, to support receiving the CSI report, the full-duplex CSI component 1555 is capable of, configured to, or operable to support a means for receiving the CSI report according to the full-duplexing mode based on the TTI including the full-duplex reference resources, where a reference resource associated with the CSI report includes a full-duplex reference resource.

In some examples, the reference resource includes one or more downlink resources and is exclusive of uplink resources based on the reference resource being the full-duplex reference resource.

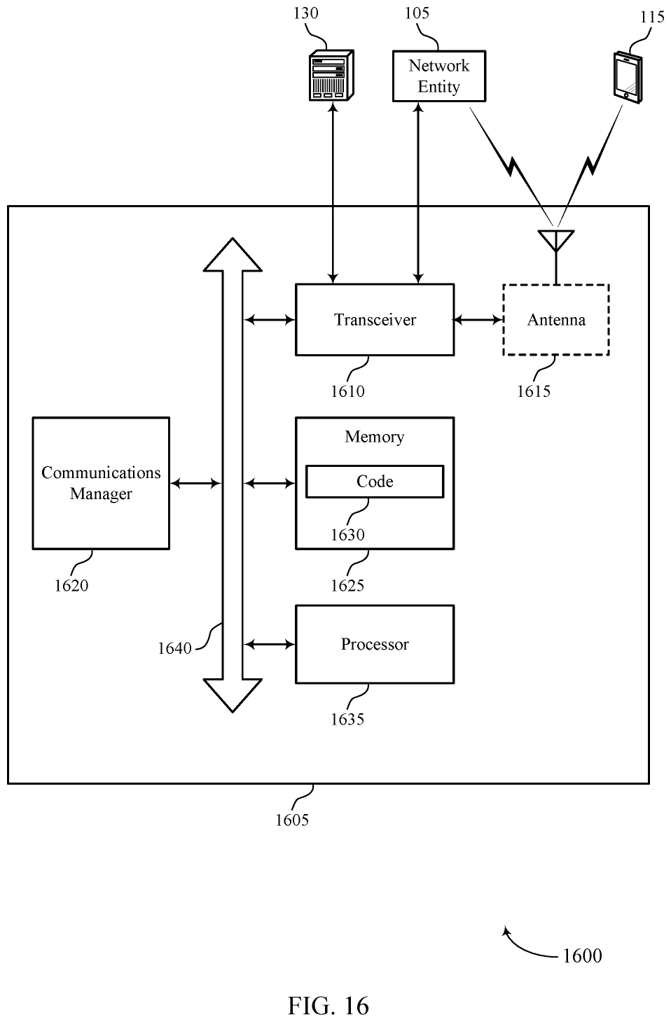

FIG. 16 shows a diagram of a system 1600 including a device 1605 that supports reference resource configuration for full-duplex and half-duplex wireless communications in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting reference resource configuration for full-duplex and half-duplex wireless communications). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

Additionally, or alternatively, the communications manager 1620 may support wireless communication at a network entity in accordance with examples as disclosed herein. For example, the communications manager 1620 is capable of, configured to, or operable to support a means for transmitting one or more reference signals including one or more full-duplex reference signals, one or more half-duplex reference signals, or both. The communications manager 1620 is capable of, configured to, or operable to support a means for receiving, at least a threshold time period after one or more reference resources, one or more CSI reports based on measurements of the one or more reference signals, the measurements associated with the one or more reference resources that are associated with full-duplex communications, half-duplex communications, or both, where the threshold time period is based on a duplexing mode associated with the one or more CSI reports.

Additionally, or alternatively, the communications manager 1620 may support wireless communication at a network entity in accordance with examples as disclosed herein. For example, the communications manager 1620 is capable of, configured to, or operable to support a means for transmitting an indication of one or more parameters for half-duplex CSI reporting, full-duplex CSI reporting, or both, the one or more parameters indicating one or more reference resources that include half-duplex reference resources, full-duplex reference resources, or both. The communications manager 1620 is capable of, configured to, or operable to support a means for transmitting, via a TTI, a reference signal, the TTI including one of the half-duplex reference resources or the full-duplex reference resources. The communications manager 1620 is capable of, configured to, or operable to support a means for receiving a CSI report associated with a duplexing mode, where the duplexing mode includes one of a half-duplexing mode based on the TTI including the half-duplex reference resources or a full-duplexing mode based on the TTI including the full-duplex reference resources.

By including or configuring the communications manager 1620 in accordance with examples as described herein, the device 1605 may support techniques for improved communication reliability, reduced latency, more efficient utilization of communication resources, and improved coordination between devices, among other examples.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of reference resource configuration for full-duplex and half-duplex wireless communications as described herein, or the processor 1635 and the memory 1625 may be otherwise configured to perform or support such operations.

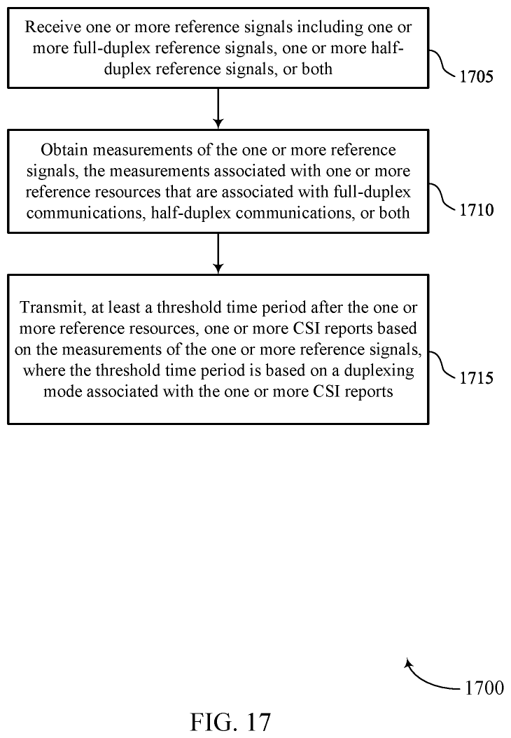

FIG. 17 shows a flowchart illustrating a method 1700 that supports reference resource configuration for full-duplex and half-duplex wireless communications in accordance with aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving one or more reference signals including one or more full-duplex reference signals, one or more half-duplex reference signals, or both. The operations of block 1705 may be performed in accordance with examples as disclosed herein. In some examples, aspects of the operations of 1705 may be performed by a reference signal component 1125 as described with reference to FIG. 11.

At 1710, the method may include obtaining measurements of the one or more reference signals, the measurements associated with one or more reference resources that are associated with full-duplex communications, half-duplex communications, or both. The operations of block 1710 may be performed in accordance with examples as disclosed herein. In some examples, aspects of the operations of 1710 may be performed by a measurement component 1130 as described with reference to FIG. 11.

At 1715, the method may include transmitting, at least a threshold time period after the one or more reference resources, one or more CSI reports based on the measurements of the one or more reference signals, where the threshold time period is based on a duplexing mode associated with the one or more CSI reports. The operations of block 1715 may be performed in accordance with examples as disclosed herein. In some examples, aspects of the operations of 1715 may be performed by a CSI report component 1135 as described with reference to FIG. 11.

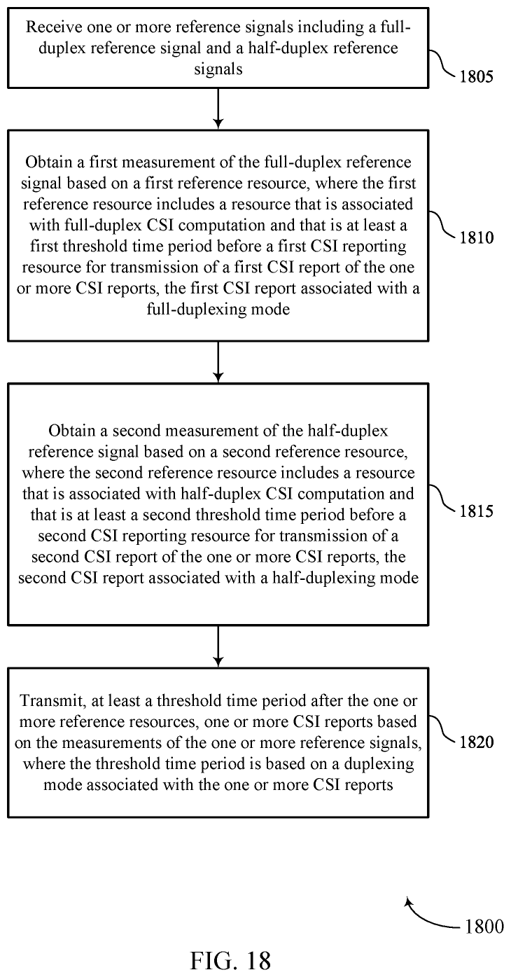

FIG. 18 shows a flowchart illustrating a method 1800 that supports reference resource configuration for full-duplex and half-duplex wireless communications in accordance with aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving one or more reference signals including a full-duplex reference signal and a half-duplex reference signal. The operations of block 1805 may be performed in accordance with examples as disclosed herein. In some examples, aspects of the operations of 1805 may be performed by a reference signal component 1125 as described with reference to FIG. 11.

At 1810, obtaining a first measurement of the full-duplex reference signal based on a first reference resource, where the first reference resource includes a resource that is associated with full-duplex CSI computation and that is at least a first threshold time period before a first CSI reporting resource for transmission of a first CSI report of the one or more CSI reports, the first CSI report associated with a full-duplexing mode. The operations of block 1810 may be performed in accordance with examples as disclosed herein. In some examples, aspects of the operations of 1810 may be performed by a full-duplex CSI component 1145 as described with reference to FIG. 11.

At 1815, the method may include obtaining a second measurement of the half-duplex reference signal based on a second reference resource, where the second reference resource includes a resource that is associated with half-duplex CSI computation and that is at least a second threshold time period before a second CSI reporting resource for transmission of a second CSI report of the one or more CSI reports, the second CSI report associated with a half-duplexing mode. The operations of block 1815 may be performed in accordance with examples as disclosed herein. In some examples, aspects of the operations of 1815 may be performed by a half-duplex CSI component 1150 as described with reference to FIG. 11.

At 1820, the method may include transmitting, at least a threshold time period after the one or more reference resources, one or more CSI reports based on the measurements of the one or more reference signals, where the threshold time period is based on a duplexing mode associated with the one or more CSI reports. The operations of block 1820 may be performed in accordance with examples as disclosed herein. In some examples, aspects of the operations of 1820 may be performed by a CSI report component 1135 as described with reference to FIG. 11.

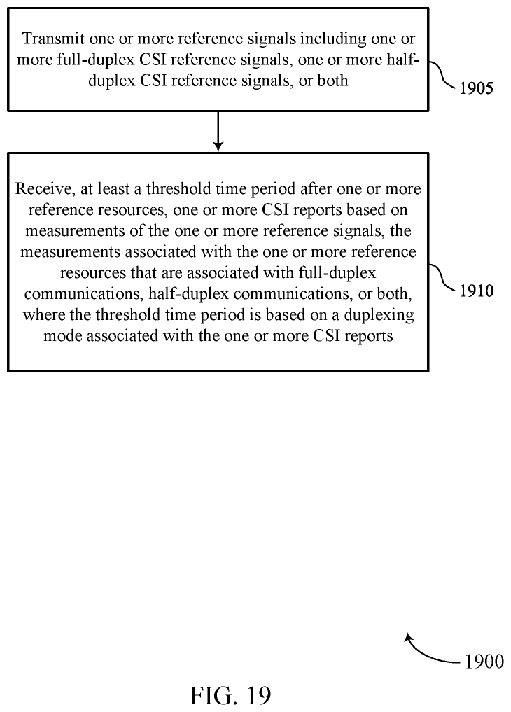

FIG. 19 shows a flowchart illustrating a method 1900 that supports reference resource configuration for full-duplex and half-duplex wireless communications in accordance with aspects of the present disclosure. The operations of the method 1900 may be implemented by a network entity or its components as described herein. For example, the operations of the method 1900 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1905, the method may include transmitting one or more reference signals including one or more full-duplex reference signals, one or more half-duplex reference signals, or both. The operations of block 1905 may be performed in accordance with examples as disclosed herein. In some examples, aspects of the operations of 1905 may be performed by a reference signal component 1525 as described with reference to FIG. 15.

At 1910, the method may include receiving, at least a threshold time period after one or more reference resources, one or more CSI reports based on measurements of the one or more reference signals, the measurements associated with the one or more reference resources that are associated with full-duplex communications, half-duplex communications, or both, where the threshold time period is based on a duplexing mode associated with the one or more CSI reports. The operations of block 1910 may be performed in accordance with examples as disclosed herein. In some examples, aspects of the operations of 1910 may be performed by a CSI report component 1530 as described with reference to FIG. 15.

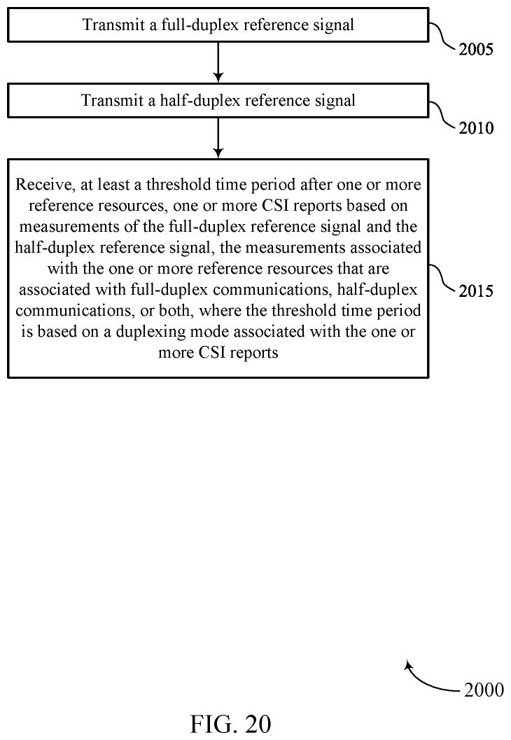

FIG. 20 shows a flowchart illustrating a method 2000 that supports reference resource configuration for full-duplex and half-duplex wireless communications in accordance with aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include transmitting a full-duplex reference signal. The operations of block 2005 may be performed in accordance with examples as disclosed herein. In some examples, aspects of the operations of 2005 may be performed by a full-duplex component 1540 as described with reference to FIG. 15.

At 2010, the method may include transmitting a half-duplex reference signal. The operations of block 2010 may be performed in accordance with examples as disclosed herein. In some examples, aspects of the operations of 2010 may be performed by a half-duplex component 1545 as described with reference to FIG. 15.

At 2015, the method may include receiving, at least a threshold time period after one or more reference resources, one or more CSI reports based on measurements of the full-duplex reference signal and the half-duplex reference signal, the measurements associated with the one or more reference resources that are associated with full-duplex communications, half-duplex communications, or both, where the threshold time period is based on a duplexing mode associated with the one or more CSI reports. The operations of block 2015 may be performed in accordance with examples as disclosed herein. In some examples, aspects of the operations of 2015 may be performed by a CSI report component 1530 as described with reference to FIG. 15.

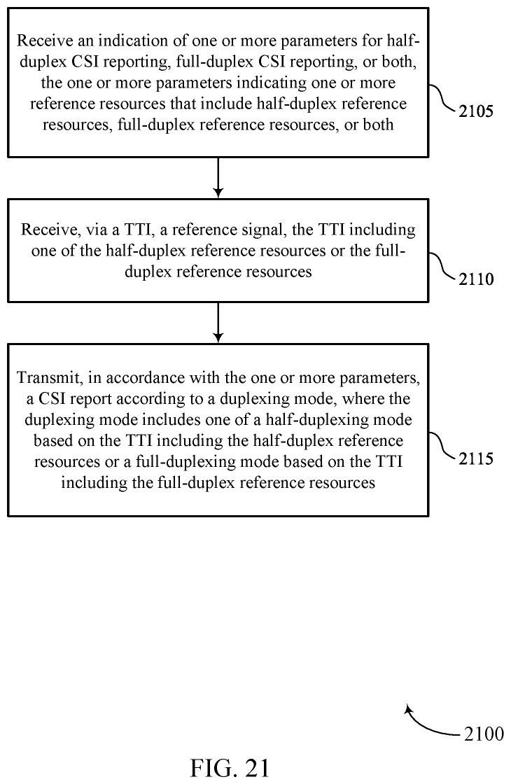

FIG. 21 shows a flowchart illustrating a method 2100 that supports reference resource configuration for full-duplex and half-duplex wireless communications in accordance with aspects of the present disclosure. The operations of the method 2100 may be implemented by a UE or its components as described herein. For example, the operations of the method 2100 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2105, the method may include receiving an indication of one or more parameters for half-duplex CSI reporting, full-duplex CSI reporting, or both, the one or more parameters indicating one or more reference resources that include half-duplex reference resources, full-duplex reference resources, or both. The operations of block 2105 may be performed in accordance with examples as disclosed herein. In some examples, aspects of the operations of 2105 may be performed by a CSI report parameter component 1140 as described with reference to FIG. 11.

At 2110, the method may include receiving, via a TTI, a reference signal, the TTI including one of the half-duplex reference resources or the full-duplex reference resources. The operations of block 2110 may be performed in accordance with examples as disclosed herein. In some examples, aspects of the operations of 2110 may be performed by a reference signal component 1125 as described with reference to FIG. 11.

At 2115, the method may include transmitting, in accordance with the one or more parameters, a CSI report according to a duplexing mode, where the duplexing mode includes one of a half-duplexing mode based on the TTI including the half-duplex reference resources or a full-duplexing mode based on the TTI including the full-duplex reference resources. The operations of block 2115 may be performed in accordance with examples as disclosed herein. In some examples, aspects of the operations of 2115 may be performed by a CSI report component 1135 as described with reference to FIG. 11.

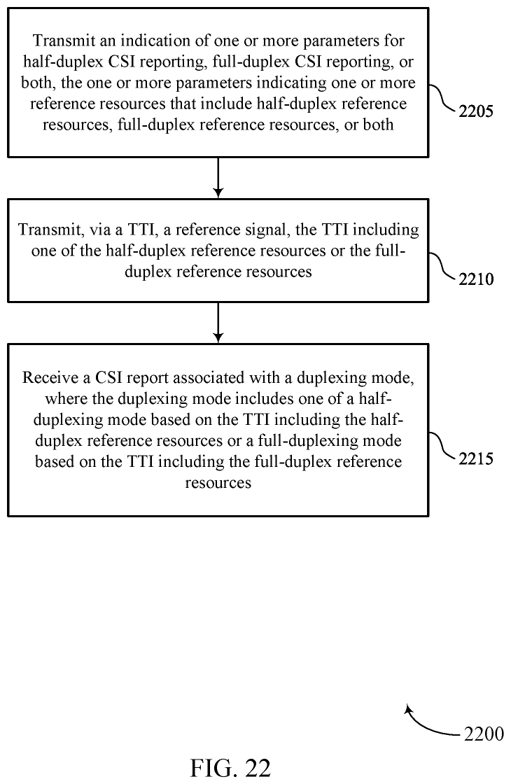

FIG. 22 shows a flowchart illustrating a method 2200 that supports reference resource configuration for full-duplex and half-duplex wireless communications in accordance with aspects of the present disclosure. The operations of the method 2200 may be implemented by a network entity or its components as described herein. For example, the operations of the method 2200 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2205, the method may include transmitting an indication of one or more parameters for half-duplex CSI reporting, full-duplex CSI reporting, or both, the one or more parameters indicating one or more reference resources that include half-duplex reference resources, full-duplex reference resources, or both. The operations of block 2205 may be performed in accordance with examples as disclosed herein. In some examples, aspects of the operations of 2205 may be performed by a CSI report parameter component 1535 as described with reference to FIG. 15.

At 2210, the method may include transmitting, via a TTI, a reference signal, the TTI including one of the half-duplex reference resources or the full-duplex reference resources. The operations of block 2210 may be performed in accordance with examples as disclosed herein. In some examples, aspects of the operations of 2210 may be performed by a reference signal component 1525 as described with reference to FIG. 15.

At 2215, the method may include receiving a CSI report associated with a duplexing mode, where the duplexing mode includes one of a half-duplexing mode based on the TTI including the half-duplex reference resources or a full-duplexing mode based on the TTI including the full-duplex reference resources. The operations of block 2215 may be performed in accordance with examples as disclosed herein. In some examples, aspects of the operations of 2215 may be performed by a CSI report component 1530 as described with reference to FIG. 15.

The following provides an overview of aspects of the present disclosure:

Aspect 1: A method for wireless communication at a UE, comprising: receiving one or more reference signals comprising one or more full-duplex reference signals, one or more half-duplex reference signals, or both; obtaining measurements of the one or more reference signals, the measurements associated with one or more reference resources that are associated with full-duplex communications, half-duplex communications, or both; and transmitting, at least a threshold time period after the one or more reference resources, one or more CSI reports based at least in part on the measurements of the one or more reference signals, wherein the threshold time period is based at least in part on a duplexing mode associated with the one or more CSI reports.

Aspect 2: The method of aspect 1, wherein the one or more reference signals comprise a full-duplex reference signal and a half-duplex reference signal, and wherein obtaining the measurements of the one or more reference signals comprises: obtaining a first measurement of the full-duplex reference signal based at least in part on a first reference resource, wherein the first reference resource comprises a resource that is associated with full-duplex CSI computation and that is at least a first threshold time period before a first CSI reporting resource for transmission of a first CSI report of the one or more CSI reports, the first CSI report associated with a full-duplexing mode; or obtaining a second measurement of the half-duplex reference signal based at least in part on a second reference resource, wherein the second reference resource comprises a resource that is associated with half-duplex CSI computation and that is at least a second threshold time period before a second CSI reporting resource for transmission of a second CSI report of the one or more CSI reports, the second CSI report associated with a half-duplexing mode; or both.

Aspect 3: The method of aspect 2, wherein transmitting the one or more CSI reports comprises: transmitting, via the first CSI reporting resource, the first CSI report comprising one or more full-duplex CSI parameters that are based at least in part on the first measurement of the full-duplex reference signal; and transmitting, via the second CSI reporting resource, the second CSI report comprising one or more half-duplex CSI parameters that are based at least in part on the second measurement of the half-duplex reference signal.

Aspect 4: The method of aspect 2, wherein transmitting the one or more CSI reports comprises: transmitting, via one of the first CSI reporting resource or the second CSI reporting resource, a single CSI report comprising one or more CSI parameters that are either based at least in part on the first measurement of the full-duplex reference signal or based at least in part on the second measurement of the half-duplex reference signal.

Aspect 5: The method of any of aspects 2 through 4, wherein: the first threshold time period is based at least in part on the first reference resource comprising the resource that is associated with full-duplex CSI computation and on a quantity of reference signal resources for channel measurements by the UE; and the second threshold time period is based at least in part on the second reference resource comprising the resource that is associated with half-duplex CSI computation and on the quantity of reference signal resources for the channel measurements by the UE.

Aspect 6: The method of aspect 1, wherein the one or more reference signals comprise a reference signal received via one or more full-duplex resources, via one or more half-duplex resources, or both, and wherein obtaining the measurements of the reference signal comprises: obtaining a first measurement of the reference signal in the one or more full-duplex resources, wherein a first reference resource for the first measurement comprises a resource that is associated with full-duplex CSI computation and that is at least a first threshold time period before a first CSI reporting resource for transmission of a first CSI report of the one or more CSI reports, the first CSI report associated with a full-duplexing mode; or obtaining a second measurement of the reference signal in the one or more half-duplex resources, wherein a second reference resource for the second measurement comprises a resource that is associated with half-duplex CSI computation and that is at least a second threshold time period before a second CSI reporting resource for transmission of a second CSI report of the one or more CSI reports, the second CSI report associated with a half-duplexing mode; or both.

Aspect 7: The method of aspect 6, wherein: a first duration of the first threshold time period is based at least in part on the first reference resource being associated with the full-duplex CSI computation and on a quantity of reference signal resources for channel measurements by the UE; a second duration of the second threshold time period is based at least in part on the second reference resource being associated with the half-duplex CSI computation and on the quantity of reference signal resources for channel measurements by the UE; and the second duration is different than the first duration.

Aspect 8: The method of any of aspects 6 through 7, wherein the first reference resource is associated with one or more CSI-RSs.

Aspect 9: The method of any of aspects 6 through 7, wherein the first reference resource is associated with one or more CSI-RSs and one or more SSBs.

Aspect 10: The method of any of aspects 6 through 9, wherein transmitting the one or more CSI reports comprises: transmitting, via the first CSI reporting resource, the first CSI report comprising one or more full-duplex CSI parameters that are based at least in part on the first measurement of the reference signal in the one or more full-duplex resources; and transmitting, via the second CSI reporting resource, the second CSI report comprising one or more half-duplex CSI parameters that are based at least in part on the second measurement of the reference signal in the one or more half-duplex resources.

Aspect 11: The method of any of aspects 6 through 9, wherein transmitting the one or more CSI reports comprises: transmitting, via one of the first CSI reporting resource or the second CSI reporting resource, a CSI report comprising either one or more full-duplex CSI parameters that are based at least in part on the first measurement of the reference signal in the one or more full-duplex resources or one or more half-duplex CSI parameters that are based at least in part on the second measurement of the reference signal in the one or more half-duplex resources.

Aspect 12: A method for wireless communication at a network entity, comprising: transmitting one or more reference signals comprising one or more full-duplex reference signals, one or more half-duplex reference signals, or both; and receiving, at least a threshold time period after one or more reference resources, one or more CSI reports based at least in part on measurements of the one or more reference signals, the measurements associated with the one or more reference resources that are associated with full-duplex communications, half-duplex communications, or both, wherein the threshold time period is based at least in part on a duplexing mode associated with the one or more CSI reports.

Aspect 13: The method of aspect 12, wherein transmitting the one or more reference signals comprises: transmitting a full-duplex reference signal; and transmitting a half-duplex reference signal.

Aspect 14: The method of aspect 13, wherein receiving the one or more CSI reports comprises: receiving, via a first CSI reporting resource, a first CSI report comprising one or more full-duplex CSI parameters that are based at least in part on the full-duplex reference signal, wherein the first CSI reporting resource is at least a first threshold time period after a first reference resource associated with the full-duplex reference signal; and receiving, via a second CSI reporting resource, a second CSI report comprising one or more half-duplex CSI parameters that are based at least in part on the half-duplex reference signal, wherein the second CSI reporting resource is at least a second threshold time period after a second reference resource associated with the half-duplex reference signal.

Aspect 15: The method of aspect 13, wherein receiving the one or more CSI reports comprises: receiving a single CSI report comprising one or more CSI parameters that are either based at least in part on the full-duplex reference signal or based at least in part on the half-duplex reference signal.

Aspect 16: The method of aspect 12, wherein transmitting the one or more reference signals comprises: transmitting a reference signal via one or more full-duplex resources, one or more half-duplex resources, or both.

Aspect 17: The method of aspect 16, wherein receiving the one or more CSI reports comprises: receiving, via a first CSI reporting resource, a first CSI report comprising one or more full-duplex CSI parameters that are based at least in part on the reference signal transmitted via the one or more full-duplex resources, wherein the first CSI reporting resource is at least a first threshold time period after a first reference resource associated with the one or more full-duplex resources; and receiving, via a second CSI reporting resource, a second CSI report comprising one or more half-duplex CSI parameters that are based at least in part on the reference signal transmitted via the one or more half-duplex resources, wherein the second CSI reporting resource is at least a second threshold time period after a second reference resource associated with the one or more half-duplex resources.

Aspect 18: The method of aspect 17, wherein the first reference resource is associated with one or more CSI-RSs.

Aspect 19: The method of aspect 17, wherein the first reference resource is associated with one or more CSI-RSs and one or more SSBs.

Aspect 20: The method of aspect 16, wherein receiving the one or more CSI reports comprises: receiving, via a CSI reporting resource, a CSI report comprising either one or more full-duplex CSI parameters that are based at least in part on the reference signal transmitted in the one or more full-duplex resources or one or more half-duplex CSI parameters that are based at least in part on the reference signal transmitted in the one or more half-duplex resources.

Aspect 21: A method for wireless communication at a UE, comprising: receiving an indication of one or more parameters for half-duplex CSI reporting, full-duplex CSI reporting, or both, the one or more parameters indicating one or more reference resources that comprise half-duplex reference resources, full-duplex reference resources, or both; receiving, via a TTI, a reference signal, the TTI comprising one of the half-duplex reference resources or the full-duplex reference resources; and transmitting, in accordance with the one or more parameters, a CSI report according to a duplexing mode, wherein the duplexing mode comprises one of a half-duplexing mode based at least in part on the TTI including the half-duplex reference resources or a full-duplexing mode based at least in part on the TTI including the full-duplex reference resources.

Aspect 22: The method of aspect 21, further comprising: obtaining measurements of the reference signal, the measurements associated with a reference resource that is associated with half-duplex CSI computation based at least in part on the TTI including the half-duplex reference resources, wherein the CSI report is transmitted according to the half-duplexing mode.

Aspect 23: The method of aspect 21, further comprising: obtaining measurements of the reference signal, the measurements associated with a reference resource that is associated with full-duplex CSI computation based at least in part on the TTI including the full-duplex reference resources, wherein the CSI report is transmitted according to the full-duplexing mode.

Aspect 24: The method of aspect 23, wherein the reference resource comprises one or more downlink resources and is exclusive of uplink resources based at least in part on the reference resource being associated with the full-duplex CSI computation.

Aspect 25: A method for wireless communication at a network entity, comprising: transmitting an indication of one or more parameters for half-duplex CSI reporting, full-duplex CSI reporting, or both, the one or more parameters indicating one or more reference resources that comprise half-duplex reference resources, full-duplex reference resources, or both; transmitting, via a TTI, a reference signal, the TTI comprising one of the half-duplex reference resources or the full-duplex reference resources; and receiving a CSI report associated with a duplexing mode, wherein the duplexing mode comprises one of a half-duplexing mode based at least in part on the TTI including the half-duplex reference resources or a full-duplexing mode based at least in part on the TTI including the full-duplex reference resources.

Aspect 26: The method of aspect 25, wherein receiving the CSI report comprises: receiving the CSI report according to the half-duplexing mode based at least in part on the TTI including the half-duplex reference resources, wherein a reference resource associated with the CSI report comprises a half-duplex reference resource.

Aspect 27: The method of aspect 25, wherein receiving the CSI report comprises: receiving the CSI report according to the full-duplexing mode based at least in part on the TTI including the full-duplex reference resources, wherein a reference resource associated with the CSI report comprises a full-duplex reference resource.

Aspect 28: The method of aspect 27, wherein the reference resource comprises one or more downlink resources and is exclusive of uplink resources based at least in part on the reference resource being the full-duplex reference resource.

Aspect 29: A UE for wireless communication, comprising: one or more memories storing processor-executable code; and one or more processors coupled with the one or more memories and individually or collectively operable to execute the code to cause the UE to perform a method of any of aspects 1 through 11.

Aspect 30: A UE for wireless communication, comprising at least one means for performing a method of any of aspects 1 through 11.

Aspect 31: A non-transitory computer-readable medium storing code for wireless communication at a UE, the code comprising instructions executable by a processor to perform a method of any of aspects 1 through 11.

Aspect 32: A network entity for wireless communication, comprising: one or more memories storing processor-executable code; and one or more processors coupled with the one or more memories and individually or collectively operable to execute the code to cause the network entity to perform a method of any of aspects 12 through 20.

Aspect 33: A network entity for wireless communication, comprising at least one means for performing a method of any of aspects 12 through 20.

Aspect 34: A non-transitory computer-readable medium storing code for wireless communication at a network entity, the code comprising instructions executable by a processor to perform a method of any of aspects 12 through 20.

Aspect 35: A UE for wireless communication at a UE, comprising: one or more memories storing processor-executable code; and one or more processors coupled with the one or more memories and individually or collectively operable to execute the code to cause the UE to perform a method of any of aspects 21 through 24.

Aspect 36: A UE for wireless communication, comprising at least one means for performing a method of any of aspects 21 through 24.

Aspect 37: A non-transitory computer-readable medium storing code for wireless communication at a UE, the code comprising instructions executable by a processor to perform a method of any of aspects 21 through 24.

Aspect 38: A network entity for wireless communication, comprising: one or more memories storing processor-executable code; and one or more processors coupled with the one or more memories and individually or collectively operable to execute the code to cause the network entity to perform a method of any of aspects 25 through 28.

Aspect 39: A network entity for wireless communication, comprising at least one means for performing a method of any of aspects 25 through 28.

Aspect 40: A non-transitory computer-readable medium storing code for wireless communication at a network entity, the code comprising instructions executable by a processor to perform a method of any of aspects 25 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories storing processor-executable code; and
one or more processors coupled with the one or more memories and individually or collectively operable to execute the code to cause the UE to:
receive one or more reference signals comprising one or more full-duplex reference signals, one or more half-duplex reference signals, or both;
obtain measurements of the one or more reference signals, the measurements associated with one or more reference resources that are associated with full-duplex communications, half-duplex communications, or both; and
transmit, at least a threshold time period after the one or more reference resources, one or more channel state information reports based at least in part on the measurements of the one or more reference signals, wherein the threshold time period is based at least in part on a duplexing mode associated with the one or more channel state information reports.

2. The UE of claim 1, wherein the one or more reference signals comprise a full-duplex reference signal and a half-duplex reference signal, and wherein, to obtain the measurements of the one or more reference signals, the one or more processors are individually or collectively operable to execute the code to cause the UE to:
obtain a first measurement of the full-duplex reference signal based at least in part on a first reference resource, wherein the first reference resource comprises a resource that is associated with a full-duplex channel state information computation and that is at least a first threshold time period before a first channel state information reporting resource for transmission of a first channel state information report of the one or more channel state information reports, the first channel state information report associated with a full-duplexing mode; or
obtain a second measurement of the half-duplex reference signal based at least in part on a second reference resource, wherein the second reference resource comprises a resource that is associated with half-duplex channel state information computation and that is at least a second threshold time period before a second channel state information reporting resource for transmission of a second channel state information report of the one or more channel state information reports, the second channel state information report associated with a half-duplexing mode; or
both.

3. The UE of claim 2, wherein, to transmit the one or more channel state information reports, the one or more processors are individually or collectively operable to execute the code to cause the UE to:
transmit, via the first channel state information reporting resource, the first channel state information report comprising one or more full-duplex channel state information parameters that are based at least in part on the first measurement of the full-duplex reference signal; and
transmit, via the second channel state information reporting resource, the second channel state information report comprising one or more half-duplex channel state information parameters that are based at least in part on the second measurement of the half-duplex reference signal.

4. The UE of claim 2, wherein, to transmit the one or more channel state information reports, the one or more processors are individually or collectively operable to execute the code to cause the UE to:
transmit, via one of the first channel state information reporting resource or the second channel state information reporting resource, a single channel state information report comprising one or more channel state information parameters that are either based at least in part on the first measurement of the full-duplex reference signal or based at least in part on the second measurement of the half-duplex reference signal.

5. The UE of claim 2, wherein:
the first threshold time period is based at least in part on the first reference resource comprising the resource that is associated with the full-duplex channel state information computation and on a quantity of reference signal resources for channel measurements by the UE; and
the second threshold time period is based at least in part on the second reference resource comprising the resource that is associated with the half-duplex channel state information computation and on the quantity of reference signal resources for the channel measurements by the UE.

6. The UE of claim 1, wherein the one or more reference signals comprise a reference signal received via one or more full-duplex resources, via one or more half-duplex resources, or both, and wherein, to obtain the measurements of the reference signal, the one or more processors are individually or collectively operable to execute the code to cause the UE to:
obtain a first measurement of the reference signal in the one or more full-duplex resources, wherein a first reference resource for the first measurement comprises a resource that is associated with full-duplex channel state information computation and that is at least a first threshold time period before a first channel state information reporting resource for transmission of a first channel state information report of the one or more channel state information reports, the first channel state information report associated with a full-duplexing mode; or
obtain a second measurement of the reference signal in the one or more half-duplex resources, wherein a second reference resource for the second measurement comprises a resource that is associated with half-duplex channel state information computation and that is at least a second threshold time period before a second channel state information reporting resource for transmission of a second channel state information report of the one or more channel state information reports, the second channel state information report associated with a half-duplexing mode; or
both.

7. The UE of claim 6, wherein:
a first duration of the first threshold time period is based at least in part on the first reference resource being associated with the full-duplex channel state information computation and on a quantity of reference signal resources for channel measurements by the UE;
a second duration of the second threshold time period is based at least in part on the second reference resource being associated with the half-duplex channel state information computation and on the quantity of reference signal resources for channel measurements by the UE; and
the second duration is different than the first duration.

8. The UE of claim 6, wherein:
the first reference resource is associated with one or more channel state information reference signals.

9. The UE of claim 6, wherein:
the first reference resource is associated with one or more channel state information reference signals and one or more synchronization signal blocks.

10. The UE of claim 6, wherein, to transmit the one or more channel state information reports, the one or more processors are individually or collectively operable to execute the code to cause the UE to:
transmit, via the first channel state information reporting resource, the first channel state information report comprising one or more full-duplex channel state information parameters that are based at least in part on the first measurement of the reference signal in the one or more full-duplex resources; and
transmit, via the second channel state information reporting resource, the second channel state information report comprising one or more half-duplex channel state information parameters that are based at least in part on the second measurement of the reference signal in the one or more half-duplex resources.

11. The UE of claim 6, wherein, to transmit the one or more channel state information reports, the one or more processors are individually or collectively operable to execute the code to cause the UE to:
transmit, via one of the first channel state information reporting resource or the second channel state information reporting resource, a channel state information report comprising either one or more full-duplex channel state information parameters that are based at least in part on the first measurement of the reference signal in the one or more full-duplex resources or one or more half-duplex channel state information parameters that are based at least in part on the second measurement of the reference signal in the one or more half-duplex resources.

12. A user equipment (UE) for wireless communication, comprising:
one or more memories storing processor-executable code; and
one or more processors coupled with the one or more memories and individually or collectively operable to execute the code to cause the UE to:
receive an indication of one or more parameters for half-duplex channel state information reporting, full-duplex channel state information reporting, or both, the one or more parameters indicating one or more reference resources that comprise half-duplex reference resources, full-duplex reference resources, or both;
receive, via a transmission time interval, a reference signal, the transmission time interval comprising one of the half-duplex reference resources or the full-duplex reference resources; and
transmit, in accordance with the one or more parameters, a channel state information report according to a duplexing mode, wherein the duplexing mode comprises one of a half-duplexing mode based at least in part on the transmission time interval including the half-duplex reference resources or a full-duplexing mode based at least in part on the transmission time interval including the full-duplex reference resources.

13. The UE of claim 12, wherein the one or more processors are individually or collectively further operable to execute the code to cause the UE to:
obtain measurements of the reference signal, the measurements associated with a reference resource that is associated with half-duplex channel state information computation based at least in part on the transmission time interval including the half-duplex reference resources, wherein the channel state information report is transmitted according to the half-duplexing mode.

14. The UE of claim 12, wherein the one or more processors are individually or collectively further operable to execute the code to cause the UE to:
obtain measurements of the reference signal, the measurements associated with a reference resource that is associated with full-duplex channel state information computation based at least in part on the transmission time interval including the full-duplex reference resources, wherein the channel state information report is transmitted according to the full-duplexing mode.

15. The UE of claim 14, wherein the reference resource comprises one or more downlink resources and is exclusive of uplink resources based at least in part on the reference resource being associated with the full-duplex channel state information computation.

16. A method for wireless communication at a user equipment (UE), comprising:
receiving one or more reference signals comprising one or more full-duplex reference signals, one or more half-duplex reference signals, or both;
obtaining measurements of the one or more reference signals, the measurements associated with one or more reference resources that are associated with full-duplex communications, half-duplex communications, or both; and
transmitting, at least a threshold time period after the one or more reference resources, one or more channel state information reports based at least in part on the measurements of the one or more reference signals, wherein the threshold time period is based at least in part on a duplexing mode associated with the one or more channel state information reports.

17. The method of claim 16, wherein the one or more reference signals comprise a full-duplex reference signal and a half-duplex reference signal, and wherein obtaining the measurements of the one or more reference signals comprises:
obtaining a first measurement of the full-duplex reference signal based at least in part on a first reference resource, wherein the first reference resource comprises a resource that is associated with full-duplex channel state information computation and that is at least a first threshold time period before a first channel state information reporting resource for transmission of a first channel state information report of the one or more channel state information reports, the first channel state information report associated with a full-duplexing mode; or
obtaining a second measurement of the half-duplex reference signal based at least in part on a second reference resource, wherein the second reference resource comprises a resource that is associated with half-duplex channel state information computation and that is at least a second threshold time period before a second channel state information reporting resource for transmission of a second channel state information report of the one or more channel state information reports, the second channel state information report associated with a half-duplexing mode; or
both.

18. The method of claim 17, wherein transmitting the one or more channel state information reports comprises:
transmitting, via the first channel state information reporting resource, the first channel state information report comprising one or more full-duplex channel state information parameters that are based at least in part on the first measurement of the full-duplex reference signal; and
transmitting, via the second channel state information reporting resource, the second channel state information report comprising one or more half-duplex channel state information parameters that are based at least in part on the second measurement of the half-duplex reference signal.

19. The method of claim 17, wherein transmitting the one or more channel state information reports comprises:
transmitting, via one of the first channel state information reporting resource or the second channel state information reporting resource, a single channel state information report comprising one or more channel state information parameters that are either based at least in part on the first measurement of the full-duplex reference signal or based at least in part on the second measurement of the half-duplex reference signal.

20. The method of claim 17, wherein:
the first threshold time period is based at least in part on the first reference resource comprising the resource that is associated with the full-duplex channel state information computation and on a quantity of reference signal resources for channel measurements by the UE; and
the second threshold time period is based at least in part on the second reference resource comprising the resource that is associated with the half-duplex channel state information computation and on the quantity of reference signal resources for the channel measurements by the UE.
